(19) United States
(12) Patent Application Publication
(10) Pub. No.: US 2023/0327860 A1
(43) Pub. Date: Oct. 12, 2023

(54) ISSUING SECRET SHARES

(71) Applicant: Hewlett-Packard Development Company, L.P., Spring, TX (US)

(72) Inventors: Yong Qi Wang, Bristol (GB); Thalia May Laing, Bristol (GB); Joshua Serratelli Schiffman, Washington, DC (US)

(73) Assignee: Hewlett-Packard Development Company, L.P., Spring, TX (US)

(21) Appl. No.: 18/042,445

(22) PCT Filed: Aug. 28, 2020
(86) PCT No.: PCT/US2020/048387

§ 371 Date: Feb. 21, 2023

(51) Int. Cl. H04L 9/08; H04L 9/30

(52) U.S. Cl. CPC H04L 9/085; H04L 9/3093

(57) ABSTRACT

Example implementations provide machine readable storage storing machine executable instructions, arranged, when processed by a processor, for a succeeding generation player device accessing an unassigned share in a secret the instructions comprising C instructions to: (a.) receive an intermediate generation share of a set of intermediate shares, the intermediate generation share being arranged to facilitate access to the unassigned share and the intermediate generation share having been derived by an intermediate generation player device from shares of further shares provided by a set of preceding generation player devices; (b.) receive, from a set of other intermediate generation player devices, a set of other intermediate generation shares of the set of intermediate shares, to facilitate access by the succeeding generation player device to the unassigned share in conjunction with the intermediate generation share; and (c.) access the unassigned share using the intermediate generation share and the set of other intermediate generation shares.

### BACKGROUND

A cryptographic secret can be shared amongst multiple player devices such that a subset of player devices can collaborate to use the secret or to make that secret available. A central entity can be tasked with issuing new shares in the secret but such an entity should be both trusted and secure, and represents a single point of failure. Such a centralized approach can be costly or impractical. Furthermore, such a central entity represents a risk that should be managed, and may not be available or otherwise online or contactable to issue new shares.

### BRIEF DESCRIPTION OF THE DRAWINGS

Example implementations will now be described, by way of example, with reference to the accompanying drawings in which:

FIG. 1 shows a (t,n) threshold scheme for issuing a share in a secret to a new player device according to example implementations;

FIG. 2 illustrates issuing a new share to a new player device according to example implementations;

FIG. 3 depicts a centralised entity or dealer according to example implementations;

FIG. 4 shows a player device according to example implementations;

FIG. 5 illustrates another dealer according to example implementations;

FIG. 6 shows another player device according to example implementations;

FIG. 7 depicts a flow chart for initialising or provisioning player devices according to example implementations;

FIG. 8 shows a pair of flow charts for providing a share to a new player device according to example implementations;

FIG. 9 illustrates a flow chart for provisioning a new player device according to example implementations;

FIG. 10 depicts another flow chart for provisioning a new player according to example implementations;

FIG. 11 shows a flow chart for provisioning a new player device according to example implementations;

FIG. 12 depicts a flow chart for provisioning a new player device according to example implementations;

FIG. 13 shows a view of a secret and a layered structure of associated shares, sub-shares and further sub-shares according to example implementations;

FIG. 14A depicts a table of shares, sub-shares and further sub-shares according to example implementations;

FIG. 14B shows an annotated view of the table of FIG. 14A according to example implementations;

FIG. 14C illustrates a share hierarchy or distribution according to example implementations;

FIG. 14D depicts a further share hierarchy according to example implementations;

FIG. 15 shows an expanded view of the table of FIG. 14A according to example implementations;

FIG. 16 shows a view of issuing a share according to example implementations;

FIG. 17 illustrates provisioning a set of n initial player devices according to example implementations;

FIG. 18 depicts a system for generating and distributing shares in a decentralised manner according to example implementations;

FIG. 19 shows a graphical view of recovering a secret according to example implementations;

FIG. 20 illustrates a further graphical view of recovering a secret according to example implementations;

FIG. 21 shows a graphical view for issuing a new share in a secret according to example implementations;

FIG. 22 depicts a further graphical view for issuing a new share in a secret according to example implementations;

FIG. 23 shows a system for generating and distributing shares in a decentralised manner according to example implementations;

FIG. 24 illustrates a graphical view of provisioning a player device according to example implementations;

FIG. 25 depicts a process for issuing a share in a secret to a new player device according to example implementations;

FIG. 26 shows hierarchical share distribution according to example implementations;

FIG. 27 illustrates a flow chart according to example implementations;

FIG. 28 shows another flow chart according to example implementations;

FIG. 29 depicts a further flow chart according to example implementations;

FIG. 30 shows yet another flow chart according to example implementations;

FIG. 31 illustrates a still further flow chart according to example implementations;

FIG. 32 shows another flow chart according to example implementations;

FIG. 33 depicts an ante-penultimate flow chart according to example implementations;

FIG. 34 shows a penultimate flow chart according to example implementations;

FIG. 35 shows a final flow chart according to example implementations; and

FIG. 36 illustrates machine-readable storage and machine-executable instructions according to example implementations.

### DETAILED DESCRIPTION

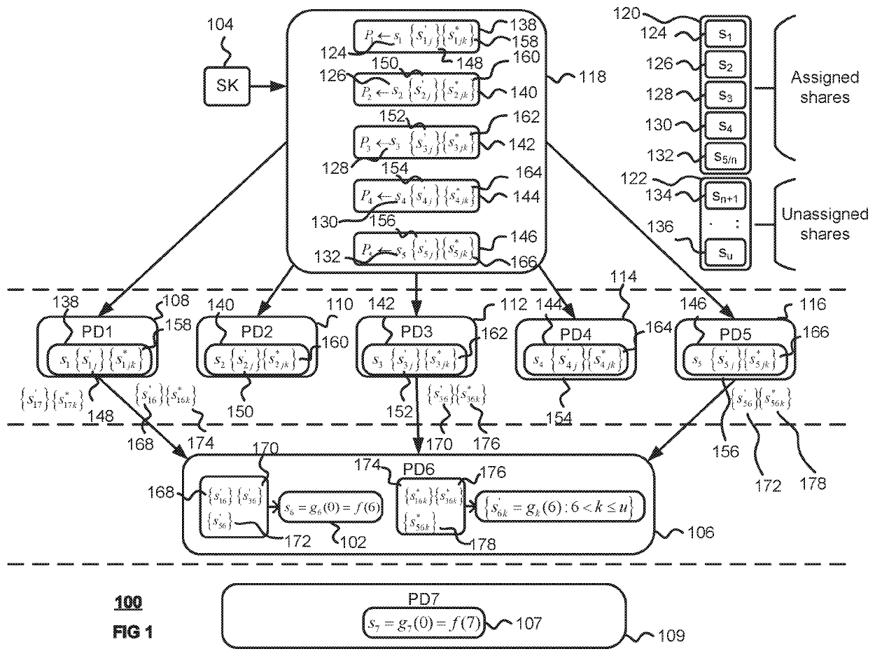

Referring to FIG. 1, there is shown a view 100 of a (t,n) threshold scheme for issuing a share 102 in a secret 104 to a new player device 106 by a number of initial player devices 108 to 116 and for provisioning the new player device 106 to assist in issuing a further share in the secret to a further new player device 109; the initial player devices 108 to 116 having been initialised or provisioned by a centralised entity 118, known as a dealer, according to an example implementation.

A player device is an example of a user device such as, for example, a computing device, which can comprise a computer, laptop, smart phone, smart wearable like a watch, or other electronic device.

A secret can comprise confidential information such as, for example, a password, a secret pin, or any other confidential information. The secret can be divided into a number of pieces of data known as shares. Each element of data, that is, each share, is derived from or is otherwise associated with the secret. The shares in a (t,n) threshold scheme are such that knowledge of t or more shares allows the secret to be determined or otherwise calculated, while knowledge of any (t−1) or fewer shares provides no information in the secret in an information theoretic sense, that is, the confidential nature of the secret is preserved such that the secret cannot be determined from (t−1) or fewer shares.

Therefore, the (t,n) threshold scheme allows t player devices of n player devices to recover a secret using respective shares in the secret, or allows the secret to be recovered if an entity such as a player device or set of player devices possesses t shares in the secret. The illustrated threshold scheme is an example of a threshold scheme in which a predetermined number, t, of player devices can cooperate to recover the secret. In the following example, it will be assumed that the threshold number of player devices needed to cooperate is three, that is, t=3 such that the threshold scheme is a (3,n) scheme.

The secret 104 is split into a number of sets of shares 120 and 122. An initial set of shares 120 of the sets of shares comprises a number of shares s₁ 124 to sₙ 132 in the secret 104 that have been assigned to respective player devices of the initial player devices 108 to 116. The shares 124 to 132 in the secret 104 are examples of assigned shares. Therefore, in the example implementation illustrated, it can be seen that assigned shares 124 to 132 have been allocated to the player devices 108 to 116 respectively. The other set of shares 122 comprises a number of shares sₙ₊₁ 134 to su 136 that are unassigned and are intended to be assigned to any new player device other than one of the initial player devices 108 to 116 such as, for example, player device 106. The shares 134 to 136 of the other set of shares 122 are examples of unassigned shares.

The dealer 118 is arranged to calculate a set of initialisation data or provisioning data corresponding to each of the initial player devices 108 to 116. In the implementation shown, therefore, the dealer 118 has calculated five sets of initialisation data 138 to 146. Each set of initialisation data 138 to 146 comprises a respective assigned share 124 to 132 of the initial set of shares 120 in the secret 104, sets of sub-shares 148 to 156 in the unassigned shares 128 to 130 be issued to be issued to new player devices such as, for example, player device 106, and sets of sub-sub shares, or further sub-shares, 158 to 166 to be issued to further player devices such a further player device 109.

The new player device 106 is an example of an intermediate or current generation player device. The initial player devices 108 to 116 are examples of preceding generation player devices relative to an intermediate or current generation player device. The further player device 109 is an example of a succeeding generation player device relative to the intermediate or current generation player device. Therefore, the initial player devices 108 to 116 are examples of such preceding generation player devices, the new player device 106 is an example of such an intermediate generation player device and the further new player device 109 is an example of such a succeeding generation player device. Shares calculated, or issued, by player devices to a given generation new player device are known as shares of that generation.

Therefore, the dealer 118 calculates:
the set of shares 138 to be assigned to player device PD1 108 to comprise
   a respective share 124 in the secret 104,
   a set or sets of shares 148 in unassigned shares of the set of unassigned shares 122 to be issued to new player devices such as new player device 106,
   a set or sets of shares 158 associated with further unassigned shares of the set of unassigned shares 122 to be issued to new player devices such as new player device 106 to allow such a new player device 106 to issue the further unassigned shares of the set of unassigned shares 122 to further new player devices such as the further new player device 109,
the set of shares 140 to be assigned to player device PD2 110 to comprise
   a respective share 126 in the secret 104,
   a set or sets of shares 150 in unassigned shares of the set of unassigned shares 122 to be issued to new player devices such as new player device 106, and
   a set or sets of shares 160 associated with further unassigned shares of the set of unassigned shares 122 to be issued to new player devices such as new player device 106 to allow such new player devices to issue the further unassigned shares of the set of unassigned shares 122 to further new player devices such as further new player device 109,
the set of shares 142 to be assigned to player device PD3 112 to comprise
   a respective share 128 in the secret 104,
   a set or sets of shares 152 in unassigned shares of the set of unassigned shares 122 to be issued to new player devices such as new player device 106, and
   a set or sets of shares 162 associated with further unassigned shares of the set of unassigned shares 122 to be issued to new player devices such as new player device 106 to allow such new player devices to issue the further unassigned shares of the set of unassigned shares 122 to further new player devices such as the further new player device 109,
the set of shares 144 to be assigned to player device PD4 114 to comprise
   a respective share 130 in the secret 104,
   a set or sets of shares 154 in unassigned shares of the set of unassigned shares 122 to be issued to new player devices such as new player device 106, and
   a set or sets of shares 164 associated with further unassigned shares of the set of unassigned shares 122 to be issued to new player devices such as new player device 106 to allow such new player devices to issue the further unassigned shares of the set of unassigned shares 122 to further new player devices such as further new player device 109,
the set of shares 146 to be assigned to player device PD5 116 to comprise
   a respective share 132 in the secret 104,
   a set or sets of shares 156 in unassigned shares of the set of unassigned shares 122 to be issued to new player devices such as new player device 106, and
   a set or sets of shares 166 associated with further unassigned shares of the set of unassigned shares 122 to be issued to new player devices such as new player device 106 to allow such new player devices to issue the further unassigned shares of the set of unassigned shares 122 to further new player devices such as the further new player device 109.

Throughout the application it will be assumed that the threshold scheme is arranged so that three cooperating player devices can recover the secret, although example implementations are not limited to such an arrangement. Example implementations can be arranged in which 2 or more cooperating player devices can recover, use or make available the secret.

In the example implementation illustrated, it can be seen that several player devices 108, 112, and 116 are cooperating in providing respective shares 168 to 172 in the unassigned share 102 of the set of unassigned shares 122 to the new player device 106. The new player device 106 uses the received shares 168, 170 and 172 to determine the respective share 102 in the secret 104 as per the (3,n) threshold scheme.

The player devices 108, 112 and 116 are also illustrated as cooperating in providing respective sets of shares 174, 176, and 178 in further unassigned shares of the set of unassigned shares 122 to be issued to further new player devices such as, for example, the further new player device 109. Although the example implementation has been described with reference to player devices 108, 112 and 116 as providing the respective sets of shares in the further unassigned shares, that is, the same player devices as described above, example implementations can be realised in which a different set of player devices can be used to issue the respective sets of shares in the further unassigned shares.

The shares 124 to 136 can be calculated from a respective polynomial ƒ(x) of degree (t−1) with a constant term corresponding to the secret 104 in which ƒ(x) is of the form ƒ(x)=Σᵢ₌₁^{t-1}αᵢxⁱ+SK, αᵢ∈ [symbol] /m [symbol] are randomly chosen coefficients and t is the threshold number of shares to use or recover the secret SK 104. Therefore, the share 124 in the secret 104 assigned to player device 108 is s₁=ƒ(1), the share 126 in the secret 104 assigned to player device 110 is s₂=ƒ(2), the share 128 in the secret 104 assigned to player device 112 is s₃=ƒ(3), the share 130 in the secret 104 assigned to player device 114 is s₄=ƒ(4), and the share 132 in the secret 104 assigned to player device 116 is s₅=ƒ(5). The foregoing assigned shares are part of the set 120 of assigned shares. Similarly, the shares 134 to 136 of the set 122 of unassigned shares are also calculated from the polynomial ƒ(x) as s₆=ƒ(6), s₇=ƒ(7), . . . , sᵤ=ƒ(u), which are to be assigned to new player devices such as, for example, new player device 106 and further new player device 109.

In general, the initial set 120 of assigned shares will comprise assigned shares s₁=ƒ(1), . . . , sₙ=ƒ(n), and the set 122 of unassigned shares will comprise unassigned shares sₙ₊₁=ƒ(n+1), . . . , sᵤ=ƒ(u), where n is the number of player devices in a set of initial player devices and u is the total number of player devices capable of participating in the secrecy system.

The sets of sub-shares 148 to 156 can be calculated from respective polynomials gⱼ(x) of degree t′ with constant terms corresponding to respective unassigned shares 134 to 136 in the secret 104 in which gⱼ(x) are of the form gⱼ(x)=Σᵢ₌₁^{t′-1}βᵢxⁱ+ƒ(j) where βᵢ∈ [symbol] /m [symbol] are randomly chosen coefficients and t′ is the threshold to assign an unassigned share ƒ(j) to a new player device 106, where n+1≤j≤u. Therefore, the sets of sub-shares 148 in the secret 104 assigned to player device 108 are s₁ⱼ=gⱼ(1), the sets of sub-shares 150 in the secret 104 assigned to player device 110 are s₂ⱼ=gⱼ(2), the sets of sub-shares 152 in the secret 104 assigned to player device 112 are s₃ⱼ=gⱼ(3), the sets of sub-shares 154 in the secret 104 assigned to player device 114 are s₄ⱼ=gⱼ(4), and the sets of sub-shares 156 in the secret 104 assigned to player device 116 are sₛⱼ=gⱼ(5). Any t′ player devices of the initial player devices 108 to 116 can cooperate in providing respective sub-shares to the new player device 106 so that the new player device 106 can calculate a respective unassigned share in the secret 104.

The sets of further sub-shares 158 to 166 can be calculated from respective polynomials h_{k,j}(x) of the form h_{k,j}(x)=Σᵢ₌₁^{t*-1}γᵢxⁱ+gₖ(j) where γᵢ∈ [symbol] /m [symbol] are randomly chosen coefficients and t* is the threshold to assign an intermediate (sub-)share to the new player device where n+1≤j≤u and j<k≤u. Therefore, the sets of further sub-shares 158 in the secret 104 assigned to player device 108 are s₁ⱼₖ=h_{k,j}(1), the sets of further sub-shares 160 in the secret 104 assigned to player device 110 are s₂ⱼₖ=h_{k,j}(2), the sets of sub-shares 162 in the secret 104 assigned to player device 112 are s₃ⱼₖ=h_{k,j}(3), the sets of sub-shares 164 in the secret 104 assigned to player device 114 are s₄ⱼₖ=h_{k,j}(4), and the sets of sub-shares 166 in the secret 104 assigned to player device 116 are s₅ⱼₖ=h_{k,j}(5). Any t* player devices of a set of player devices comprising the initial player devices 108 to 116 and the new player device 106 can cooperate in providing respective sub-shares to the further new player 109 so that the further new player 109 can calculate a respective unassigned share s₇=ƒ(7) 107 in the secret 104 from the received sub-shares.

Therefore, in general, a newly added nth generation player device can be assigned a respective unassigned share in the secret selected from the set 122 of unassigned shares 134 to 136 if earlier preceding generations, or existing, player devices have been provisioned or provided with respective sets of (n−1)t″ shares, etc. from which a newly added nth generation player device can calculate a respective unassigned share in the secret. Each time a new player device is added, the former (t, n) threshold scheme becomes a (t, n+1) threshold scheme. Therefore, when player device 106 is added, the former (t, 5) threshold scheme became a (t, 6) threshold scheme. Similarly, when player device 109 was added, the former (t, 6) threshold scheme became a (t, 7) threshold scheme, and when the next player device is added, the former (t, 7) threshold scheme will become a (t, 8) threshold scheme and so on. It can be seen that the threshold to recover the secret remains constant even though the threshold schemes change (t, n)→(t, n+1)→(t, n+2)→(t, n+3)→ . . . →(t, u) when all u player devices are present.

Therefore, initialising or provisioning the original player devices 108 to 116 with the foregoing data allows the initial player devices 108 to 116 to initialise or provision a new player device such as new player device 106 that, in turn, allows any set of player devices, which can include or exclude the new player device 106 relative to the set of initial player devices, to assign an unassigned share of the set of unassigned shares 122 in the secret 104 to a further new player device such as further new player device 109.

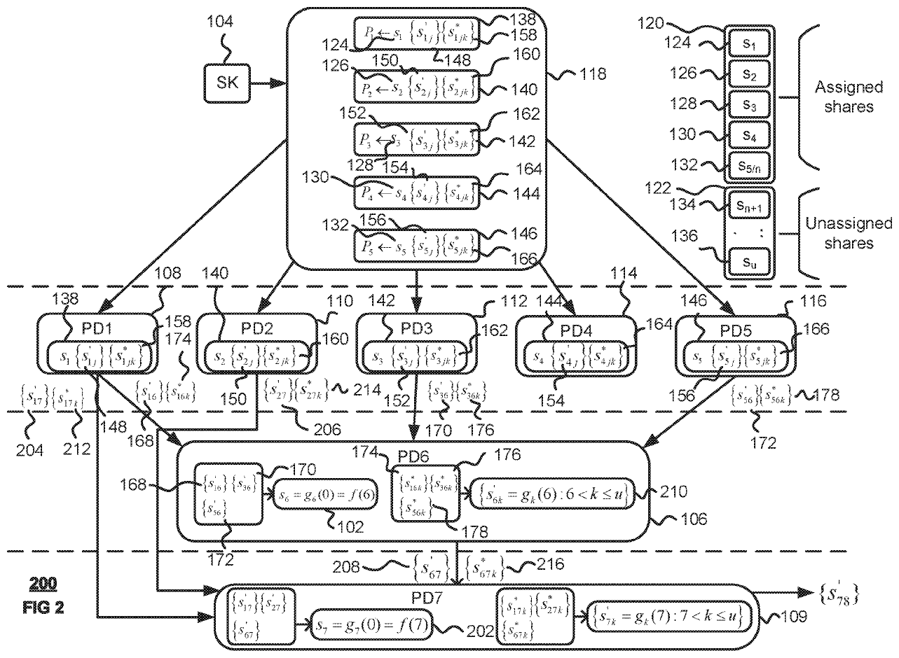

Referring to FIG. 2, there is depicted a view 200 of issuing a new share 202 to the further new player device 109 according to example implementations. Reference numerals common to FIGS. 1 and 2 refer to the same entity. It can be appreciated that each of the initial player devices 108 to 116 has been initialised or provisioned with respective sets of shares 158 to 166 in the unassigned shares 134 to 136. The respective sets of shares 158 to 166 can be provided to subsequently added, that is, succeeding generation, player devices such as, for example, player device PD7 109 to enable the further new player device 109 to determine its respective share 202 in the secret 104.

In the example implementation depicted in FIG. 2, it is assumed that player devices 108, 110 and 116 collaborate by providing respective sub-shares 204, 206 and 208 in the share 202 to be issued or otherwise assigned to the further new player device 109 so that the further new player device 109 can calculate its respective share 202 in the secret 104. It can be appreciated that the further new player device 109 determines or calculates its respective share 202 in the secret 104 by constructing a respective polynomial g₇(x) and evaluating that polynomial at x=0, that is, the respective share 202 of the further new player device 109 is given by s₇=g₇(0)=ƒ(7).

To enable the new player device 106 to participate in providing the further new player device 109 with access to its respective share 202 in the secret 104, the new player device 106 is initialised or provisioned by a predetermined threshold number of succeeding generation player devices with further sub-shares from which the new player device 106 can determine or calculate an additional sub-share or additional sub-shares in any remaining unassigned shares 134 to 136.

Therefore, assuming that the set 122 of unassigned shares 134 to 136 comprises three unassigned shares; namely s₆, s₇, and s₈, the new player device 106 would be provided with sets of shares 174, 176 and 178 from which the new player device 106 can calculate such shares 210 in any remaining unassigned shares 134 to 136 in the secret 104. An example of such a share in an unassigned share is, for example, the share 208 provided by the new player device 106 to the further new player device 109. Such a share 208 was derived from the sets of further sub-shares 174, 176 and 178 provided to the new player device 106 by respective player devices 108, 112 and 116.

In a similar manner, the further new player device 109 can be initialised or otherwise provisioned by a set of existing player devices providing respective sets of further sub-shares 212, 214 and 216 to the further new player device 109 from which the further new player device 109 can calculate respective shares in any remaining unassigned shares of the set of unassigned shares 122. The set of existing player devices can comprise a respective threshold number of player devices selected from the set of all player devices that have been previously provisioned to issue unassigned shares. Therefore, the further new player device 109 can use the respective shares to at least one, or both, of facilitate a still further player device access its respective share or to provision such a still further player device to issue unassigned to a further succeeding generation player device. In the example depicted in FIG. 2, the respective shares would comprise any of {s′ᵢ₈} (not shown) received from a respective threshold number of any previously provisioned player devices 106 to 116 to allow the still further player device, that is, player device PD8 (not shown), to determine s₈=g₈(0)=ƒ(8), which can comprise receiving sub-share {s′₇₈} 218 from the further new player device 109 since the further new player device 109 will have been provisioned via respective further sub-shares {s*ᵢ₇ₖ} 212, 214, 216 received from a respective threshold set of previously provisioned preceding generation player devices 106, 108, 110.

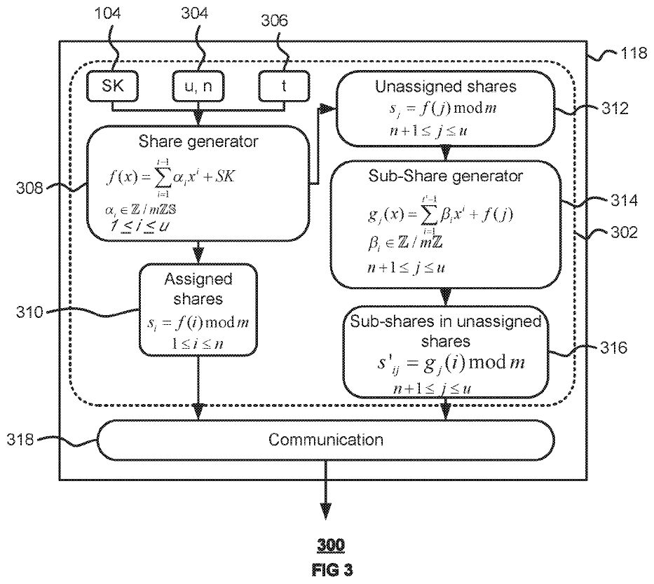

Referring to FIG. 3, there is shown a view 300 of the centralised entity or dealer 118 for generating the data sets, that is, the secret, all shares and the various sub-shares, further sub-shares and successive layers of shares in preceding shares for provisioning the set of n initial player devices 108 to 116. The dealer 118 comprises a processor 302. The processor 302 stores, or has access to, the secret 104, an indication 304 of the total number, u, of shares in the secret 104 to be created and a set of n initial player devices, and an indication 306 of a threshold number of player devices to collaborate to assign an unassigned share 134 to 136 in the secret 104.

The dealer 118 comprises a respective share generator 308 for generating shares in the secret 104. In the example shown, the share generator 308 can be realised using software that is executed or otherwise processed by the processor 302. The respective share generator 308 generates the shares in the secret 104 using the respective polynomial ƒ(x) of degree (t−1) with a constant term corresponding to the secret 104 in which ƒ(x) is of the form ƒ(x)=Σᵢ₌₁^{t-1}αᵢxⁱ+SK, αᵢ∈ [symbol] /m [symbol] are randomly chosen coefficients, t is the threshold number of shares that can be used to issue or recover SK and 1≤i≤u. As indicated above the shares sᵢ=ƒ(i)mod m comprise assigned shares 310 that are assigned to the set of n initial player devices. The assigned shares 308 are examples of the above described assigned shares 124 to 132.

The dealer 118 also uses the share generator 308 to generate unassigned shares 312 sⱼ=ƒ(j)mod m, where n+1≤j≤u. The unassigned shares 312 are examples of the above described unassigned shares 134 to 136.

The dealer comprises a sub-share generator 314 to generate sub-shares 316 in the unassigned shares 312. The sub-share generator 314 generates the sub-shares 316 in the unassigned shares 312 using respective polynomials gⱼ(x) of degree t′ with constant terms corresponding to the unassigned shares 312 in the secret 104 in which gⱼ(x) are of the form gⱼ(x)=Σᵢ₌₁^{t′-1}βᵢxⁱ+ƒ(j) where βᵢ∈ [symbol] /m [symbol] are randomly chosen coefficients and t′ is the threshold to assign an unassigned share ƒ(j) to a new player device such as, for example, the new player device 106, where n+1≤j≤u. The sub-shares 316 are given by s′ᵢⱼ=gⱼ(i) mod m, where n+1≤j≤u. The sub-shares 316 in the unassigned shares 312 are examples of the above sub-shares 134 to 136.

The dealer 118 can also comprise a communication interface 318 for communicating the shares 310 and sub-shares 316 to respective player devices of the set of n initial player devices. The dealer 118 distributes respective shares 310 and respective sub-shares 316 to the set of n initial player devices 108 to 116.

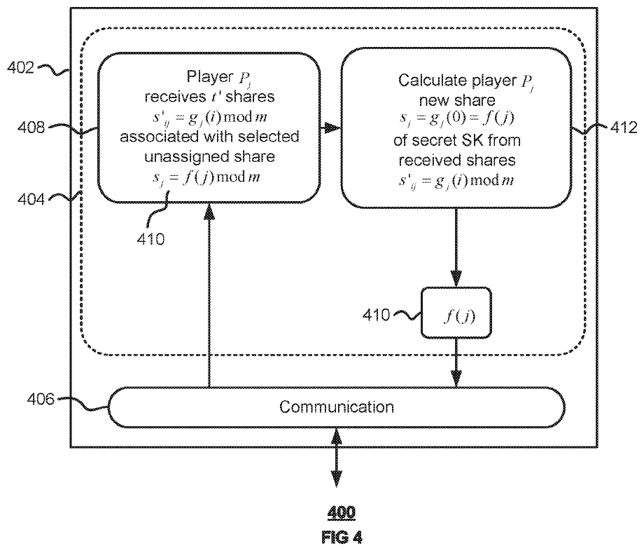

Referring to FIG. 4, there is shown a view 400 of a player device 402, that is, player device j. The player device 402 is an example of the above described player devices 106 to 116. The player device 402 comprises a processor 404 and a communication interface 406. The communication interface 406 is arranged to receive sub-shares s′ᵢⱼ=gⱼ(i)mod m 408 associated with an unassigned share 410 for the player device 402 from a predetermined threshold number, t′, of player devices. The sub-shares 408 are examples of the above described sub-shares 316.

The processor 404 comprises a share calculator 412. The share calculator 412 calculates the unassigned share 410 of the secret 104 from the received sub-shares 408. The unassigned share 410 is an example of the above described unassigned shares 134 to 136. The calculated hitherto unassigned share 410 is deemed to be assigned to the player device 402. The player device 402 can use the share 410 to recover the secret 104 in collaboration with (t−1) other player devices.

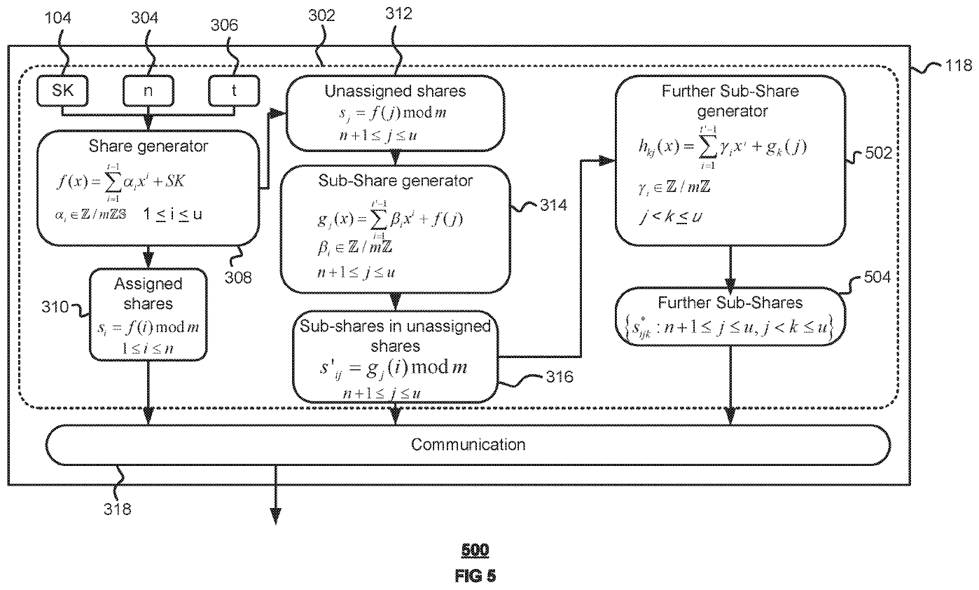

Referring to FIG. 5, there is shown a view 500 of example implementations of the dealer 118 for issuing shares to further new player devices such as, for example, the above described further new player device 109. The reference numerals that are common to FIGS. 3 and 5 refer to the same elements. The processor 302 is arranged to implement a further sub-share generator 502, that is, a sub-sub-share generator. The further sub-share generator 502 is arranged to generate further sub-shares 504 in sub-shares 316 in the unassigned shares 312, 134 to 136. The further sub-shares 504 are examples of the above described further sub-shares 158 to 166. The further sub-shares 504 are calculated from respective polynomials h_{k,j}(x) of the form h_{k,j}(x)=Σᵢ₌₁^{t*-1}γᵢxⁱ+gₖ(j) where γᵢ∈ [symbol] /m [symbol] are randomly chosen coefficients, t* is the threshold to assign a respective sub-share to the further new player device, n+1≤j≤u and j<k≤u. It can be seen that each further sub-share polynomial generates shares to provide access to respective constant terms gₖ(j). The further sub-shares can be issued to respective player devices via the communication interface 318.

Therefore, more multiple layers can be defined with each subsequent or next layer having associated generator polynomials to generate shares in the shares of the immediately preceding layer to enable newer generations of player devices to issue shares to even newer generation player devices.

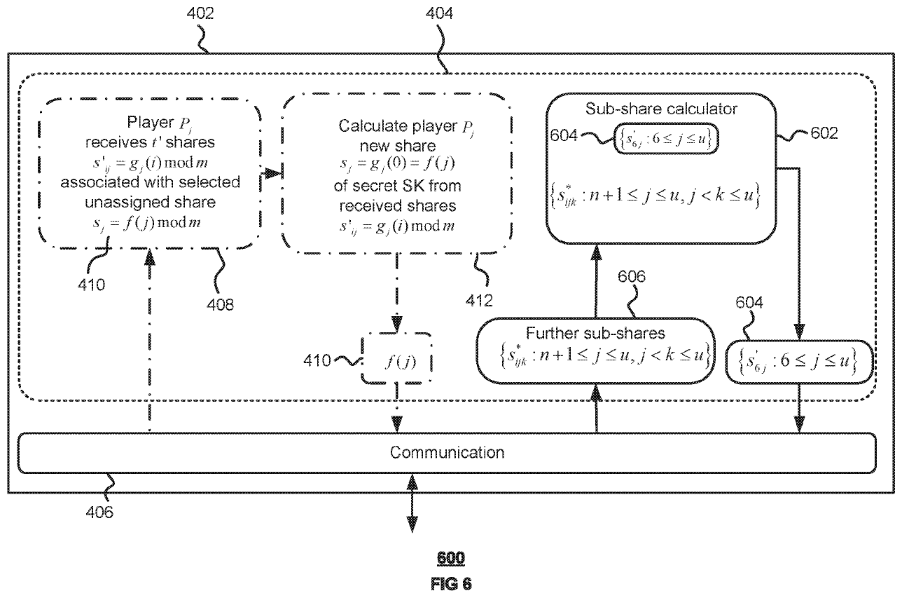

Referring to FIG. 6, there is shown a view 600 of an example implementation of a player device 402. The player device 402 is an example of any of the above described player devices 106 to 116. Reference numerals common to FIGS. 4 and 6 refer to the same entity. The entities in the dash-dot outline may or may not be included in the example implementation shown in FIG. 6. The processor 404 is configured with a sub-share calculator 602. The sub-share calculator 602 is arranged to calculate a set of sub-shares 604 from further sub-shares 606 received from other player devices. The sub-shares 604 are examples of the above described sub-shares 148 to 156, 168 to 172, 204 to 208 and 210. The further sub-shares 606 are examples of the above described further sub-shares 158 to 166, 212 to 216.

The player device 402 can selectively output one or more of the sub-shares 604 to one or more respective new player devices to facilitate those player devices accessing respective shares in the secret 104 or respective shares associated with the secret 104 such as, for example, respective further sub-shares in the secret. The respective shares associated with the secret can comprise one or more shares in one or more other shares associated with the secret. Any and all example implementations described herein can be realised in which multiple levels or layers of shares in shares are used to facilitate access to a share or shares in the secret.

Example implementations can be realised in which the player device 402 additionally comprises the entities shown in dash-dot format such that the player device can determine its own respective share in the secret and provide at least one of sub-shares, further sub-shares or multiple layers of shares to facilitate at least a further new player device access a respective share in the secret.

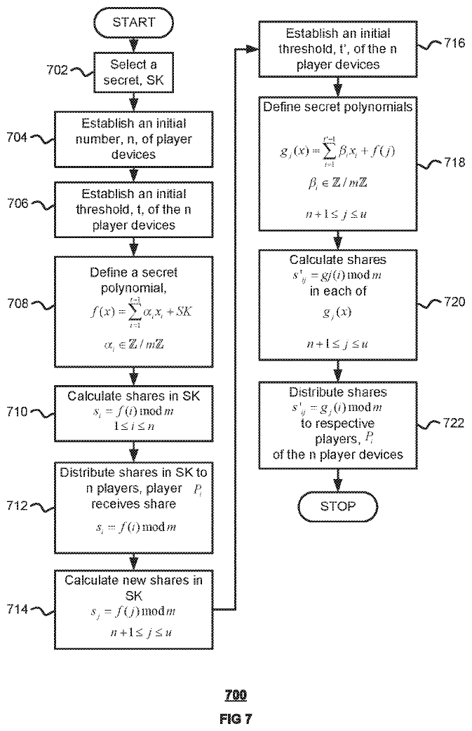

Referring to FIG. 7, there is shown a flow chart 700 for initialising or provisioning player devices to facilitate a new player device access a share in a secret. A secret is selected at 702. The secret can be the above described secret 104 or any share in any share associated with such a secret 104. An initial number of player devices is determined at 704. At 706 a threshold t is selected to establish a (t,n) threshold scheme. A secret polynomial from which the shares in the secret can be determined is established at 708.

In the example illustrated, the secret polynomial is the above described polynomial ƒ(x). However, the secret polynomial can equally well be any of the above described polynomials ƒ(x), gⱼ(x), h_{k,j}(x) or any other generator polynomial selected for generating shares in the secret or selected for generating shares in shares, in particular, selected for generating shares in shares, associated with a secret. It can be appreciated that shares in a share effectively treats the latter share as a secret. Therefore, at each layer or generation of shares, a share of one layer is the secret for shares of the immediately preceding layer such that those generation shares facilitate a player device of the immediately succeeding layer in accessing the share from which those shares were generated.

Shares in the secret are calculated at 710. The shares calculated at 710 are distributed to the set of n initial player devices at 712. The shares calculated at 710 are examples of the above described assigned shares 124 to 132. Therefore, at 712 the set of n initial player devices are initialised or provisioned with respective shares {sᵢ=ƒ(i), 1≤i≤n} in the secret. Any t of the set of n initial player devices can collaborate to recover the secret.

At 714, additional shares in the secret are calculated. The additional shares calculated at 712 are examples of the above described unassigned shares 134 to 136. It will be appreciated that example implementations can be realised that combine 710 and 712 to calculate the assigned shares and unassigned shares.

A further threshold scheme is established for distributing the unassigned shares calculated at 712. Therefore, at 716, a threshold number, t′, of player devices is established. Generator polynomials are established or accessed, at 718, for generating set of shares in the unassigned shares. The generator polynomials are examples of the above described generator polynomials gⱼ(x). At 720, shares in the unassigned shares are generated at 720 from the generator polynomials. The respective shares of the generated shares are distributed to the set of n initial player devices for subsequent distribution to respective new player devices. It can be appreciated, for example, that an i^{th} player device, Pᵢ, of the set of n initial player devices receives a respective set {s′ᵢⱼ=gⱼ(i), n+1≤j≤u} of the generated shares. Therefore, n initial player devices receive or are otherwise initialised or provisioned with respective sets of shares {s′ᵢⱼ=gⱼ(i), 1≤i≤n; n+1≤j≤u}. Consequently, any t′ player devices can collaborate to facilitate a new player device, Pⱼ, accessing a respective share, in the secret from shares, stiff, in the respective share, sⱼ, provided to the new player device, Pⱼ, by the t′ collaborating player devices.

Referring to FIG. 8, there is shown a view 800 of a pair of flow charts 802 and 804 for providing a share in a secret to the new player device, Pᵢ. At 806, a dealer, such as the above described dealer 118, or a provisioned player device, such as any of the above described player devices 106 to 116, identifies the new player device, Pᵢ, to receive or otherwise be issued with, or provide access to, a respective share, in the secret. At 808, an unassigned share, in the secret is selected from the set 122 of unassigned shares 134 to 136. At 810, a respective player device issues a share as one of a predetermined threshold number, t′, of shares, stiff, in the unassigned share, sⱼ, that are selected and output to the new player device, Pᵢ, by t′ collaborating previously provisioned player devices. The collaborating previously provisioned player devices can comprise any t′ collaborating previously provisioned player devices. Therefore, the collaborating previously provisioned player devices can comprise one or more than one newly added player device that was not one of the set of n initial player devices.

At the new player device, Pᵢ, the predetermined number, t′, of shares, stiff, in the unassigned share, sⱼ, are received, at 812. The unassigned share, in the secret is calculated, at 814, by the new player device, Pᵢ, from the predetermined number, t′, of shares, sⱼ, in the unassigned share, sᵢ. Therefore, a subset of t′ player devices of any previously provisioned player devices can facilitate access by a new player device, Pⱼ, to an unassigned share, sⱼ, in the secret.

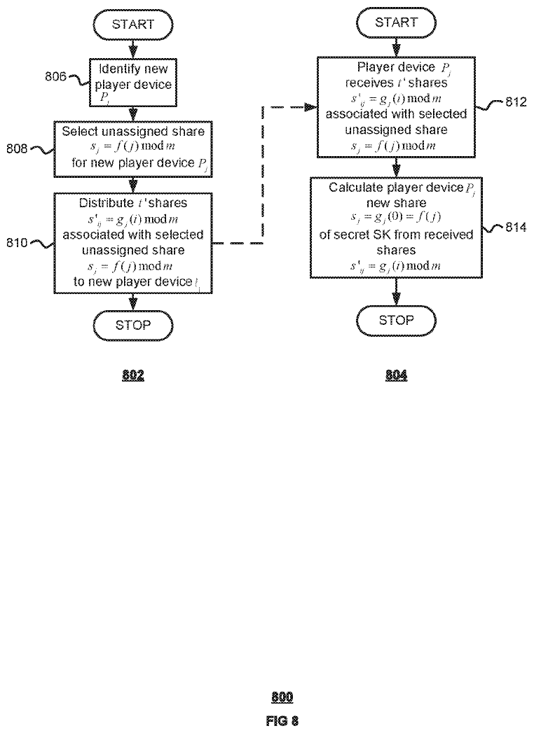

Referring to FIG. 9, there is shown a flow chart 900 for provisioning a new player device, Pⱼ, n+1≤j≤u, to facilitate a further new player device, Pₖ, j+1≤k≤u, in accessing a respective share, sₖ=ƒ(k), in a secret from further sub-shares, {s*ᵢⱼₖ:n+1≤j≤u, j<k≤u}, associated with the secret; the further sub-shares having been generated from the above described respective polynomials h_{k,j}(x) of the form h_{k,j}(x)=Σᵢ₌₁^{t*-1}γᵢxⁱ+gₖ(j) where γᵢ∈ [symbol] /m [symbol] are randomly chosen coefficients, t* is the threshold to assign an intermediate share, that is, a sub-share to the further new player device, and n+1≤j≤u and j<k≤u of the secret. Reference numerals common to FIGS. 7 and 9 refer to the same entity or action.

Therefore, at step 902, a number of generator polynomials, such as the above described respective polynomials h_{k,j}(x), are selected to generate the further sub-shares, or sub-sub-shares, in sub-shares in shares in the secret. The further sub-shares are shares that are associated with, or otherwise derived from, the secret via at least one layer of an intermediate share or intermediate shares in, or similarly associated with, the secret. At 904, the further sub-shares are calculated from the above described respective polynomials h_{k,j}(x) and the further sub-shares are distributed to respective player devices.

Initially, the further sub-shares will be distributed to the set of n initial player devices 108 to 116 to facilitate one or more than one new player device in accessing a respective share in the secret and to provision such a new player device, in turn, to facilitate a further new player device in accessing a respective share in the secret and/or to provision that further new player device. As more player devices are provisioned, respective layers of such shares are generated and distributed.

It will be noted that several aspects of FIG. 9 are illustrated in a dashed outline such as 712, 714 and 722. The dashed outline operations may or may not also form part of the example implementation; FIG. 11 described below shows the above dashed outline features as part of the example implementation.

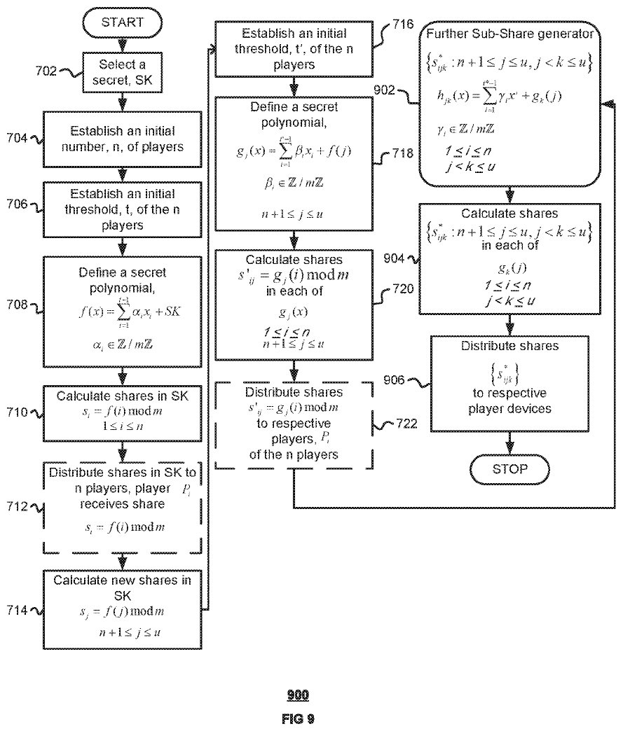

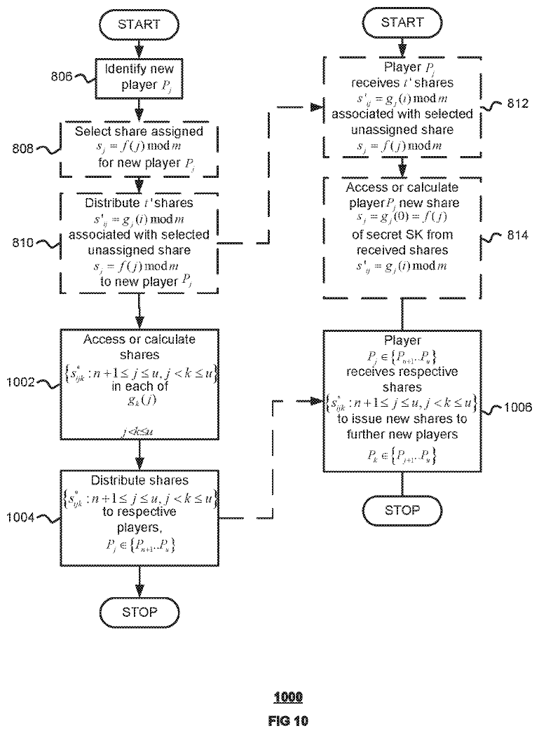

Referring to FIG. 10, there is shown a flow chart 1000 fora player device provisioning a new player device, Pⱼ, to facilitate issuing a share in a secret to a further new player, Pₖ. Reference numerals common to FIGS. 8 and 10 refer to the same entities or actions. At 806, a new player, Pⱼ, is identified to be provisioned for issuing a respective share, sₖ=ƒ(k), in the secret 104 to a further new player, Pₖ. Further sub-shares, {s*ᵢⱼₖ:n+1≤j≤u, j<k≤u}, in the respective share, sₖ=ƒ(k), in the secret 104 are calculated or accessed at 1002. The further sub-shares are distributed by the player device to the new player device, Pⱼ, at 1004.

At 1006, the new player device, Pⱼ, receives from a set of t* previously provisioned player devices respective further sub-shares {s*ᵢⱼₖ:n+1≤j≤u, j≤k≤u} in the respective shares {s′_{i,j}} to be issued to subsequently added new player devices such as, for example, the further new player device 109, to facilitate issuing shares in the secret to any such subsequently added new player devices like the further new player, Pₖ. The further new player device, Pₖ, is an example of the above described player device 109.

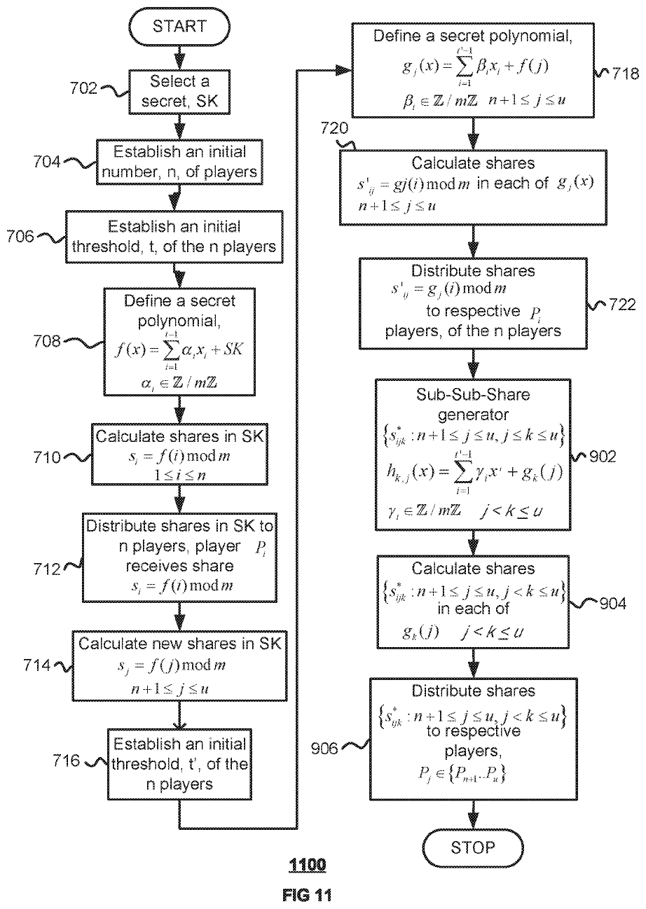

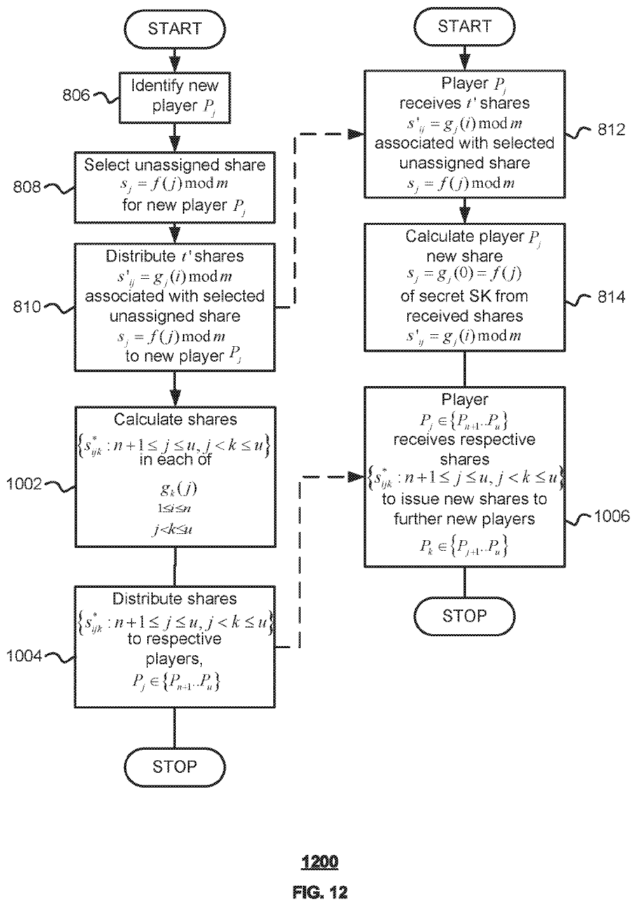

Example implementations can be realised in which the actions associated with 808 to 814 shown in dashed outline can also be performed in addition to 806, 1002 to 1006, which would provide the new player device, Pⱼ, with access to its respective share, sⱼ=ƒ(j), in the secret 104, at 812 and 814, and provision the new player device, Pⱼ, by receiving from the set of t* previously provisioned player devices respective further sub-shares {s*ᵢⱼₖ:n+1≤j≤u, j≤k≤u} in the respective shares to be issued to subsequently added new player devices such as, for example, the further new player device 109, to facilitate issuing shares in the secret to any such subsequently added new player devices like the further new player device, Pₖ, 109. Such an example implementation is shown in FIG. 12, where the hitherto dashed outline is shown in solid line form.

Referring to FIG. 11, there is shown a flow chart for provisioning a new player device such as, for example, new player device 106 with a respective share in the secret, with respective sub-shares in hitherto unassigned shares in the secret to be assigned to subsequently added player devices, and with further sub-shares in sub-shares in hitherto unassigned shares in the secret to be assigned to further subsequently added player devices. Such a new player device can be the above described player device 106, such a subsequently added player device can be the above described player device 107 and such a further subsequently added player device could be the above or below described player device PD8 (not shown).

Referring to FIG. 12, there is shown a flow chart 1200 for a player device provisioning a new player device. Reference numerals common to FIGS. 10 and 12 refer to the same operations. It can be seen that the hitherto operations 808, 810, 812 and 814 are shown in the flow chart 1200 of FIG. 12 as being part of the same respective example implementations.

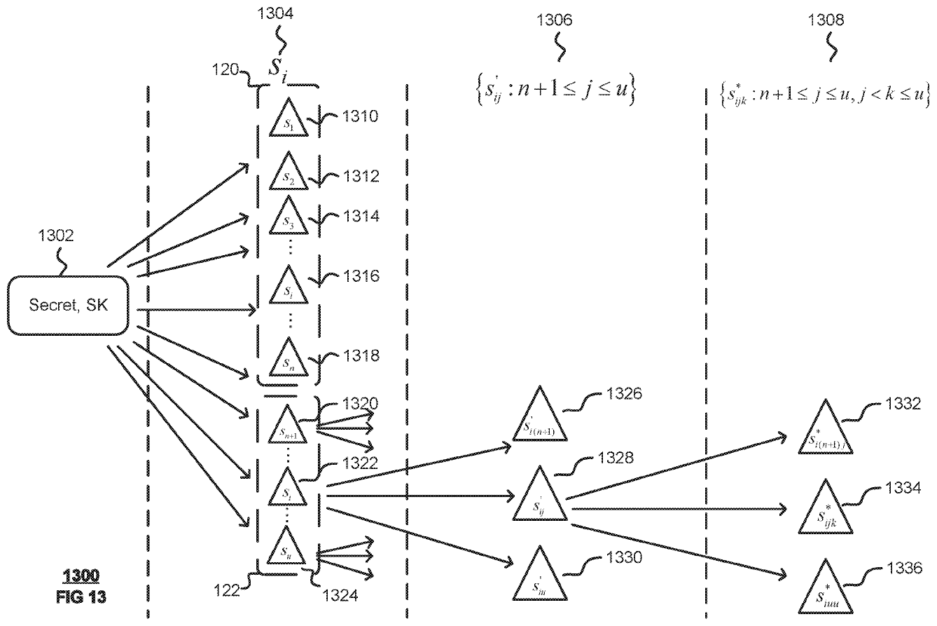

Referring to FIG. 13, there is shown a view 1300 of a secret 1302 and associated generations or layers 1304 to 1308 of shares 1310 to 1324, sub-shares 1326 to 1330 and further sub-shares 1332 to 1336 in the secret 1302. The secret 1302 is an example of the above described secret 104. The shares 1310 to 1324 are examples of the above describes assigned 124 to 132 and unassigned shares 134 to 136. The sub-shares 1326 to 1330 are examples of the above described sub-shares 148 to 156. The further sub-shares 1332 to 1336 are examples of the above described further sub-shares 158 to 166.

The secret 1302 has been divided into, or has derived therefrom, a number of shares 1310 to 1324. The shares 1310 to 1324 comprise two sets of shares; namely, assigned shares 1310 to 1318 and unassigned shares 1320 to 1324. The assigned shares are examples of the above described assigned shares 124 to 132. The unassigned shares are examples of the above described unassigned shares 134 to 136. The assigned shares 1310 to 1318 are assigned to respective player devices of the set of n initial player devices 108 to 116. Each of the unassigned shares 1320 to 1324 are divided into respective sub-shares. In the example shown, one such unassigned share 1322 in the secret 1302 has been divided into three sub-shares 1326 to 1330. Furthermore, one of the sub-shares 1328 has been divided into three further sub-shares 1332 to 1336. However, each sub-share 1326 to 1330 can be divided into respective numbers of further sub-shares generated using respective generator polynomials arranged to be recovered using respective thresholds.

A new player device, Pⱼ n+1≤j≤u, can be provided with access to one of the unassigned shares 1322 in the secret 1302 by receiving the three sub-shares 1326 to 1330 from previously provisioned player devices. Similarly, the new player device, Pⱼ, can be provisioned with a respective sub-share 1328 in the secret 1302 by receiving respective further sub-shares 1332 to 1336 in the secret from previously provisioned player devices. Although the provisioning for preceding generation shares has been described using shares of the same layer or generation, example implementations are not limited to such an arrangement.

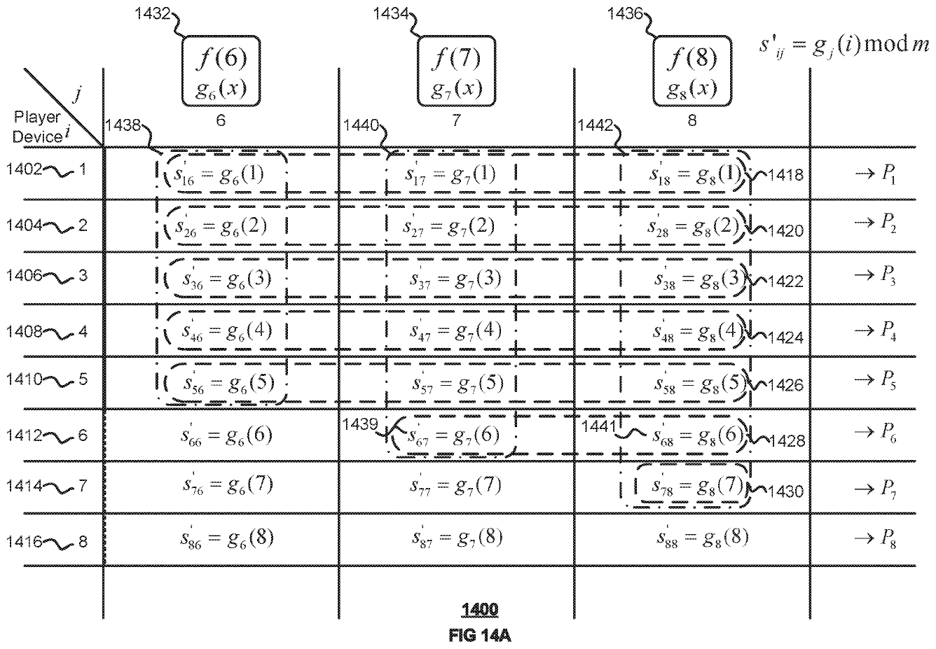

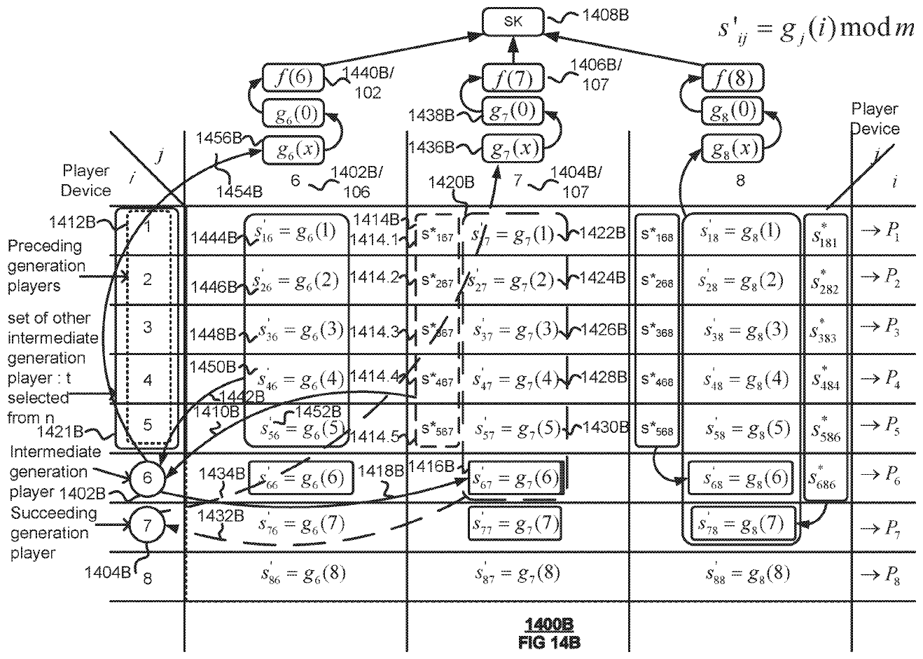

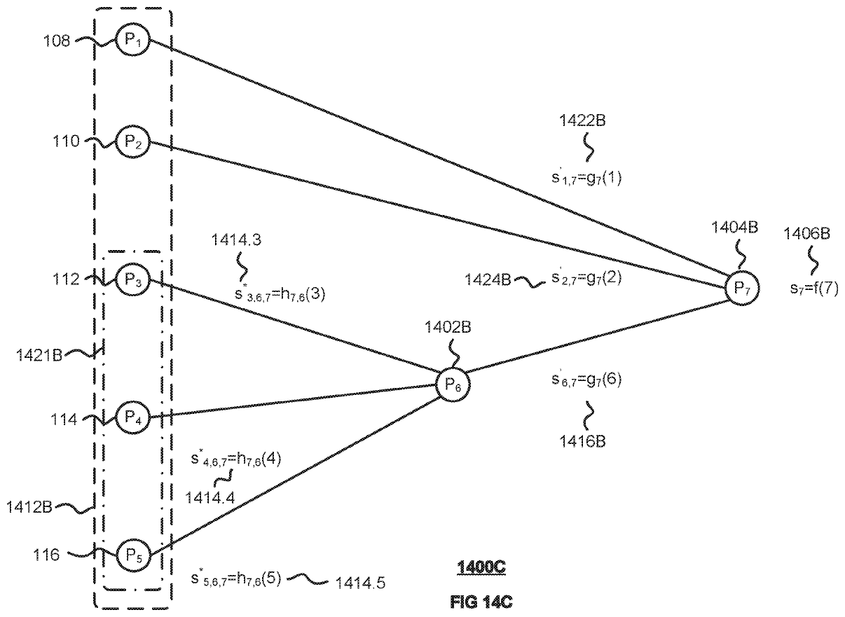

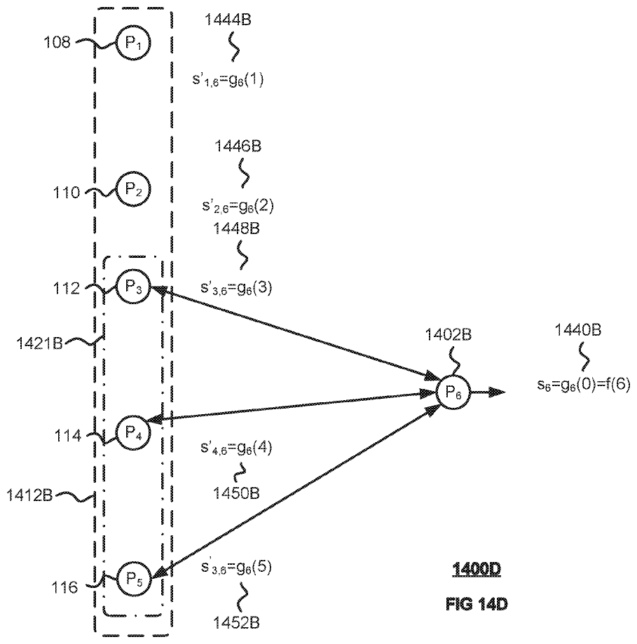

Referring to FIG. 14A, there is shown a view 1400 of a table of shares and sub-shares in a secret (not shown) according to example implementations. The shares and sub-shares of the table are examples of any of the above described shares and sub-shares. The table assumes a maximum, or upper limit, of u player devices. In the example shown, u=8. The eight player devices comprise a set of five initial player devices 1402 to 1410 and a set of three new player devices 1412 to 1416. The five initial player devices 1402 to 1410 are examples of the above described set of n initial player devices 108 to 116. The new player devices 1412 to 1416 are examples of the above described new player device 106, further new player device 109 and still further player device PD8.

The set of five initial player devices 1402 to 1410 are provisioned with sets of sub-shares 1418 to 1426 relating to each of the unassigned shares 1432 to 1436. Therefore,
player device 1402 is initialised with {s′₁ⱼ=gⱼ(1), n+1≤j≤u}, that is, with {s′₁₆=g₆(1), s′₁₇=g₇(1), s′₁₈=g₈(1)},
player device 1404 is initialised with {s′₂ⱼ=gⱼ(2), n+1≤j≤u}, that is, with {s′₂₆=g₆(2), s′₂₇=g₇(2), s′₂₈=g₈(2)},
player device 1406 is initialised with {s′₃ⱼ=gⱼ(3), n+1≤j≤u}, that is, with {s′₃₆=g₆(3), s′₃₇=g₇(3), s′₃₈=g₈(3)},
player device 1408 is initialised with {s′₄ⱼ=gⱼ(4), n+1≤j≤u}, that is, with {s′₄₆=g₆(4), s′₄₇=g₇(4), s′₄₈=g₈(4)},
player device 1410 is initialised with {s′₅ⱼ=gⱼ(5), n+1≤j≤u}, that is, with {s′₅₆=g₆(5), s′₅₇=g₇(5), s′₅₈=g₈(5)}.

In general, the set of n initial player devices 1402 to 1410 receive or are otherwise initialised or provisioned with respective sets of shares {s′ᵢⱼ=g (i), 1≤i≤n; n+1≤j≤u}.

Once the player devices 1402 to 1410 have been provisioned as indicated above, a subset of t player devices, selected from the set of provisioned player devices 1438, can collaborate to enable a new player device 1412 to access a respective share 1432 of the secret. For example, the new player device 1412 can access the respective share 1432 using sub-shares received from any t of the player devices such as player devices 1402, 1406 and 1410, which provide sub-shares s′₁₆=g₆(1), s′₃₆=g₆(3), and s′₅₆=g₆(5) to player device 1412, which facilitates the player device 1412 in calculating s₆=g₆(0)=ƒ(6) as depicted in FIGS. 1 and 14A.

Furthermore, the set of player devices 1438 is also provisioned with further sub-shares (not shown) in s′₆₇=g₇(6) 1439 determined from {s*ᵢⱼₖ:1≤i≤n, n+1≤j≤u, j<k≤u}, in particular, further sub-shares {s*ᵢⱼₖ:1≤i≤n, j=6, k=7}. Therefore, any of t* player devices of the set of player devices 1438 can facilitate the new player device 1412 being provisioned with, or otherwise facilitate access to, a sub-share s′₆₇=g₇(6) such that t player devices of the set 1440 of player devices can facilitate access by a further player device 1414 to a respective share 1434 in the secret. For example, player devices 1404, 1406, 1408 can provide respective further sub-shares {s*ᵢⱼₖ=2, j=6, k=7}, {s*ᵢⱼₖ=3, j=6, k=7} and {s*ᵢⱼₖ=4, j=6, k=7} to player device 1412 to allow player device 1412 to calculate s′₆₇=g₇(6), that, in turn, allows player device 1414 to calculate s₇=g₇(0)=ƒ(7) so that player device 1414 can participate in at least one, or both, of recovering or using the secret or in recovering or using the respective share.

Furthermore, the set of player devices 1438 is also provisioned with further sub-shares (not shown) in s′₆₈=g₈(6) 1441 determined from {s*ᵢⱼₖ:1≤i≤n, n+1≤j≤u, j≤k≤u}, in particular, further sub-shares {s*ᵢⱼₖ:1≤i≤n, j=6, k=8}. Therefore, any of t* player devices of the set 1438 of player devices can facilitate the new player device (PD8 or P8) 1412 being provisioned with, or otherwise facilitate access to, a sub-share s′₆₈=g₈(6) such that t player devices of the set of player devices 1442 can facilitate access by a still further player device 1416 to a respective share 1436 in the secret. For example, player devices 1402, 1406, 1408 can provide respective further sub-shares {s*ᵢⱼₖ: i=1, j=6, k=8}, {s*ᵢⱼₖ:i=3, j=6, k=8} and {s*ᵢⱼₖ: i=4, j=6, k=8} to player device 1412 to allow player device 1412 to calculate s′₆₈=g₈(6), that, in turn, allows player device 1416 to calculate s₈=g₈(0)=ƒ(8) so that player device 1416 can participate in recovering the secret.

Still further, the set of player devices 1438 is arranged to provision the further set of player devices 1440 with still further sub-shares {s**ᵢⱼₖₗ:1≤i≤n, n+1≤j≤u, j<k≤u, k≤l≤u}) to facilitate the further player device 1414 to in calculating s′₇₈=g₈(7) that, in turn, allows a still further player device 1416 to access or calculate a respective share, s₈=ƒ(8), in the secret.

Referring to FIG. 14B, there is shown an annotated view 1400B of the data table 1400 of FIG. 14A according to example implementations. The annotated view 1400B will be used to demonstrate provisioning a new player device 1402B to provide shares to a further new player device 1404B to facilitate the further new player device 1404B to access a respective share 1406B of the secret 1408B. The secret 1408B is an example of any of the above described secrets such as secret 104. The new player device 1402B is an example of the above described new player device 106 as well as an example of an intermediate generation player device. The further new player device 1404B is an example of the above described further new player device 109 as well as an example of a succeeding generation player device. The respective share 1406B of the secret 1408B is an example of the above described respective share 107 of the secret 104.

Assume that the set of n initial player devices comprises player devices 108 to 116, and that the new player device 106 will be added to the set of player devices followed by the further new player device 109.

At 1410B, a set 1412B of player devices of the initial set of n initial player devices provides a threshold number of shares from a set 1414B of shares 1414.1 to 1414.5 to the new player device 106. The shares of the set 1414B of shares are examples of further sub-shares as well as being examples of preceding generation shares. The set 1412B of player devices is an example of a set of preceding generation player devices. The set 1414B of shares are shares in an intermediate generation share 1416B. The intermediate generation share 1416B is an example of a sub-share. The intermediate generation share 1416B can be calculated from a threshold number of shares of the set 1414B of shares. The shares of the set 1414B of shares are examples of preceding generation shares. The intermediate generation share 1416B provisions the new player device 1402B to facilitate the further new player device 1404B in providing access to the secret 1408B via the respective share 1406B.

At 1418B, the new player 1402B calculates the intermediate generation share 1416B from the threshold number of shares and stores the results, which provisions or otherwise initialises the new player 1402B to assist the further new player 1404B. The intermediate generation share 1416B forms part of a set 1420B of such intermediate generation shares. The set 1420B of intermediate generation shares comprises the intermediate share 1416B and a number of other shares 1422B to 1430B in the respective share 1406B associated with a set 1421B of other intermediate generation player devices P1 . . . P5. The other shares 1422B to 1430B are examples of other intermediate generation shares.

At 1432B, a threshold number of shares of the set 1420B of intermediate generation shares are provided to the further new player 1404B, from which the further new player 1404B calculates, at 1434B, the respective generator polynomial g₇(x) 1436B from which the further new player device 1404B can calculate the constant term g₇(0) 1438B to make the respective share ƒ(7) 1406B in the secret 1408B available to the further new player 1404B.

Accordingly, example implementations provide a computer implemented method for issuing an unassigned share ƒ(7) 1406B to a succeeding generation player device 1404B, the method comprising: a set of preceding generation player devices P1 . . . P5 1412B providing, to an intermediate generation player device P6 1402B, preceding generation shares 1414B to allow the intermediate generation player device P6 1402B to calculate an intermediate generation share s₆₇=g₇(6) 1416B from which the succeeding generation player device P7 1404B, together with a set 1421B or subset of other intermediate generation shares s′₁₇=g₇(1) . . . s′₅₇=g₇(5) 1422B to 1430B provided by respective other intermediate generation player devices P1 . . . P5 1421B, can calculate the unassigned share g₇(0)=s₇=ƒ(7) 1406B; and the intermediate generation player device P6 1402B and the set 1421B of other intermediate generation player devices providing the intermediate generation share 1416B and the set of the other intermediate generation shares s′₁₇=g₇(1) . . . s′₅₇=g₇(5) 1422B to 1430B to the succeeding generation player device P7 1404B.

It will be appreciated from the above that a player device can simultaneously be a preceding generation player device and an intermediate generation player device. For example, referring to FIG. 14C, it can be appreciated that all of the player devices 108 to 116 are in the set of preceding generation player devices with a threshold number of those player devices 112 to 116 having been selected to provide further sub-shares 1414.3 to 1414.5 to the new player device 1402B. Consequently, those player devices 112 to 116 are preceding generation player devices that provide preceding generation shares 1414.3 to 1414.5 to an intermediate generation player device 1402B from which the intermediate generation player device 1042B can determine the respective intermediate generation share 1416B. However, the same set of player devices 108 to 116 comprises two player devices 108 and 110 that provide intermediate generation shares 1422B and 1424B to the further player device 1404B. Therefore, those two player devices 108, 110, or any other player devices 108 to 116 and 1402B providing, or provisioned to provide, intermediate generation shares to the further player device 1404B are also intermediate generation player devices.

Therefore, the terms preceding generation player device, intermediate generation player device and succeeding generation player device are relative. Relative to a given succeeding generation player device, any device that provides a share from which said succeeding generation player device can calculate a respective share is an intermediate generation player device. It can be seen that there is a direct connection or communication between a succeeding generation player device and an intermediate generation player device.

Similarly, a preceding generation player device is a preceding generation player device relative to an intermediate generation player device, that is, a preceding generation player device comprises any player device that provides a share to an intermediate generation player device from which the latter can calculate a respective share; said respective share to be provided to a respective succeeding generation player device. Therefore, such a preceding generation player device will not be directly connected or in communication with the succeeding generation player device other than via the intermediary of an intermediate generation player device.

Furthermore, example implementations facilitate accessing the unassigned share 1406B in the secret by the further new player device 1404B with that access being facilitated by the new player device 1402B and a threshold number of the set of n initial player devices, that is, a threshold number of preceding generation player devices.

Referring to FIG. 14C, there is shown a view 1400C of the hierarchy of shares used in the process described above with reference to FIG. 14B. FIG. 14C shows the further new player device 1404B, that is, a succeeding generation player device, accessing the respective share 1406B in the secret 1408B. The new player 1402B is provisioned by a set or subset 1421B of the set 1412B of n initial player devices 108 to 116 to access the intermediate generation share 1416B. The subset of the preceding generation player devices 112 to 116 provide respective further sub-shares s*_{3,6,7}=h_{7,6}(3) 1414.3, s*_{4,6,7}=h_{7,6}(4) 1414.4 to s*,_{5,6,7}=h_{7,6}(5) 1414.5 to the new player device 1402B. The new player device 1402B uses the respective further sub-shares s*_{3,6,7}=h_{7,6}(3) 1414.3, s*_{4,6,7}=h_{7,6}(4) 1414.4 to s*_{5,6,7}=h_{7,6}(5) 1414.5 to calculate the intermediate generation share h_{7,6}(0)=s′_{6,7}=g₇(6) 1416B.

The new player device 1402B, that is, the intermediate generation player device, provides the intermediate generation share 1416B to the further new player device 1404B, that is the succeeding generation player device. A subset of the set 1412B of n initial player devices, that is, the other intermediate generation player devices, provide respective intermediate generation shares s′_{1,7}=g₇(1) 1422B and s′_{2,7}=g₇(2) 1424B to the further new player device 1404B so that the further new player device 1404B has a threshold number of shares s′_{i,7}=g₇(1) 1422B, s′₂₇=g₇(2) 1424B, s′_{6,7}=g₇(6) 1416B from which to calculate the respective share s₇=ƒ(7) 1406B in the secret 1408B. Share 1406B is an example of the above described share 1432.

Therefore, in general, a preceding generation player device, player device i, is in possession of a respective share, ƒ(i), in the secret, and sends or can send gⱼ(i) and {h_{j+1,j}(i) to h_{u,j}(i)} to a player device j in a current generation (player device j); a current generation player device, player device j, receives respective shares from a threshold number of player devices in the, or a, preceding generation or preceding generations, calculates a respective share, ƒ(j), in the secret, calculates gⱼ₊₁(j) to gᵤ(j), and sends or can send gₖ(j) to a player device, player device k, in the succeeding generation; and the succeeding generation player device, player device k, in the succeeding generation, receives respective subshares from a threshold number of player devices in the preceding generation or preceding generations from which to calculate a respective share, ƒ(k), in the secret.

Although the example implementation has been described with reference to player devices 112 to 116 forming the set of preceding generation player devices, example implementations are not limited to such an arrangement. The set of preceding generation player devices could comprise any threshold number of player devices selected from the set of n initial player devices 108 to 116. Similarly, although the example implementation has been described with reference to the two player devices 108 and 110 providing respective intermediate generation shares to the further player device 1404B, example implementations are not limited to such an arrangement. Example implementations can be realised in which the threshold number of intermediate generation shares are provided by a respective threshold number of any of the player devices 108 to 116 including the new player device 1402B.

Still referring to FIG. 14B, example implementations can additionally, or alternatively, comprise a threshold scheme for providing the new player device 1402B with access to a respective share 1440B in the secret 1408B. The new player device 1402B is an example of the above described new player device 106. The respective share 1440B is an example of the above described respective share 102.

At 1442B, a threshold number of player devices of the set of n initial player devices 108 to 116 provides the threshold number of respective sub-shares selected from sub-shares 1444B to 14452B to the new player device 1402B.

At 1454B, the new player device 1402B calculates the respective generator polynomial g₆(x) 1456B from which the respective share s₆=g₆(0)=ƒ(6) 1440B can be calculated.

Therefore, it can be appreciated that the set of n initial player devices 108 to 116 can be provisioned or initialised with shares 1444B to 1452B to enable the new player device 1402B to be issued with a respective share ƒ(6) 1440B in the secret 1408B. Share 1440B is an example of the above described share 1434.

Referring to FIG. 14D, there is shown the processing of the hierarchy of shares described above with reference to FIG. 14B for providing the new player device 1402B with access to its respective share 1440B in the secret 1408B. The set 1412B of initial player devices 108 to 116 have been provisioned with, or otherwise generate or have generated, respective sub-shares 1444B to 1452B in the respective share 1440B of the new player device 1402B in the secret 1408B.

A threshold number of player devices 112 to 116 provide respective sub-shares 1448B to 1452B to the new player device 1402B. The new player devices 1402B uses the threshold number of received sub-shares 1448B to 1452B to calculate the respective share 1440B in the secret 1408B.

Therefore, existing player devices, that is, previously provisioned player devices, have issued a hitherto unassigned share 1406B or 1440B in the secret 1408B to at least one, or both, of the new player devices 1404D and 1402B.

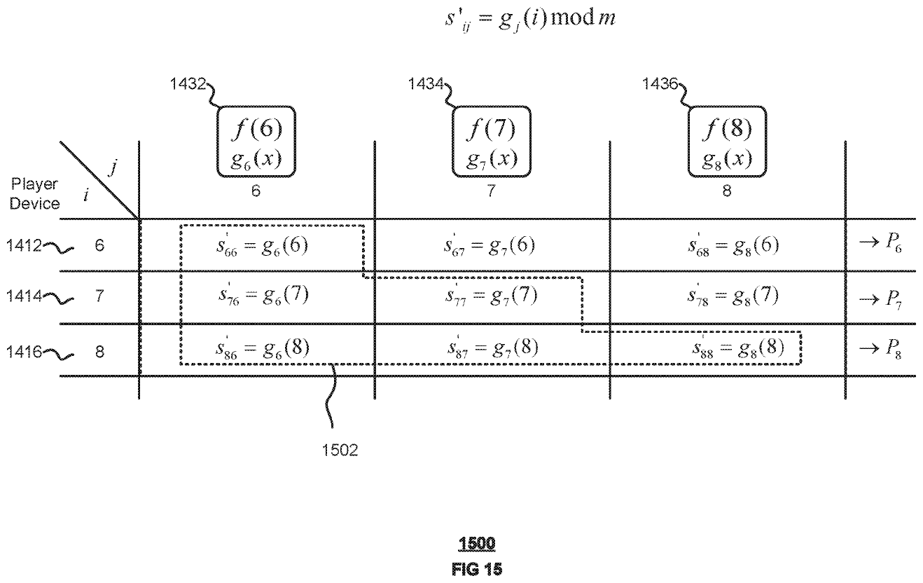

Referring to FIG. 15, there is shown an expanded view 1500 of the table of shares and sub-shares in the secret of FIG. 14A. It can be appreciated that there is a set 1502 of sub-shares that does not need to be calculated providing that the unassigned shares are allocated in order, that is, unassigned share ƒ(6) 1432 is assigned before unassigned share ƒ(7) 1434 and that unassigned share ƒ(7) 1434 is assigned before un assigned share ƒ(8) 1436, that is, in general, assigning the unassigned shares {sⱼ=ƒ(j):n+1<j<u} are allocated in order of ascending j can reduce the computational overhead of the provisioning. Therefore, if the shares ƒ(6), ƒ(7), ƒ(8) are issued in order, the seventh player device does not have to calculate g₆(7) and the eighth player device does not have to calculate g₆(8) or g₇(8).

Therefore, it will be appreciated that:
an (n+1)^{th} player device should be able to calculate gₙ₊₂(n+1), gₙ₊₃(n+1), gₙ₊₄(n+1), . . . , gᵤ(n+1);
an (n+2)^{th} player device should be able to calculate gₙ₊₃(n+2), gₙ₊₄(n+2), gₙ₊₅(n+2), . . . , gᵤ(n+2); and so on such that
a (u−2)^{th} player device should be able to calculate gᵤ₋₁(u−2), gᵤ(u−2), and
an (u−1)^{th} player device should be able to calculate gᵤ(u−1).

Applying the foregoing to a set of 5 initial player devices and 3 subsequently added player devices, that is, n=5 and u=8, gives:
player device 6 should be able to calculate g₇(6) and g₈(6), and
player device 7 should be able to calculate g₈(7).

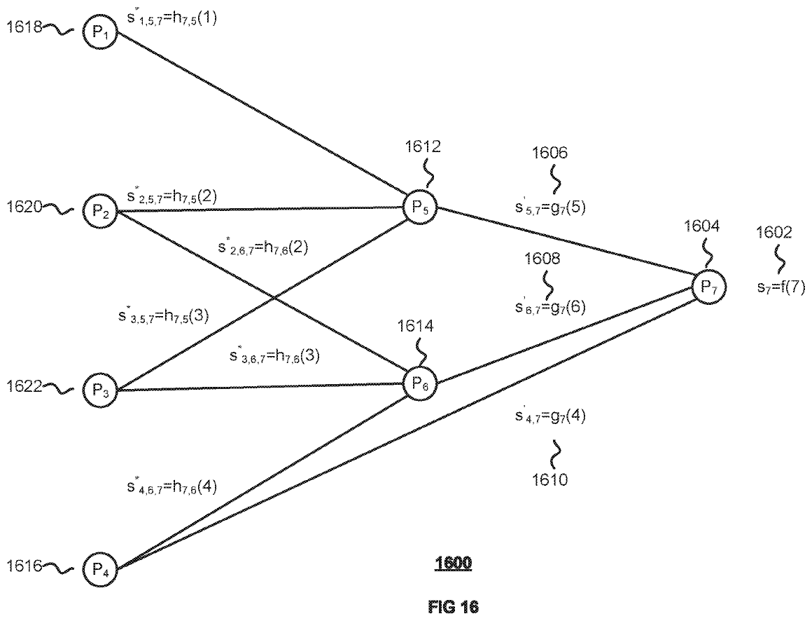

Referring to FIG. 16, there is shown an alternative view 1600 of issuing a share s₇=g₇(0)=ƒ(7) 1602 to a player device 1604. The player device 1602 is an example of the above described further player device 109. It can be seen that the player device 1604 receives sub-shares s′₅₇=g₇(5) 1606, s′₆₇=g₇(6) 1608 and s′₄₇=g₇(4) 1610 in the share 1602 from respective player devices 1612, 1614 and 1616 from which the player device 1604 can calculate the respective share s₇=g₇(0)=ƒ(7) 1602 in the secret.

An initial set of player devices 1616 to 1622 were provisioned with respective further sub-shares in the sub-shares 1606 and 1608 issued by two new player devices 1612 and 1614 so that those new player devices can facilitate the player device 1604 in accessing the respective share s₇=g₇(0)=ƒ(7) 1602 in the secret. Therefore, the initial set of player devices were provisioned with respective further sub-shares {s*ᵢⱼₖ:1≤i≤n, n+1≤j≤u, j<k≤u}, that is, {s*ᵢⱼₖ:1≤i≤n, n+1≤j<k≤u} if the unassigned shares are issued in order. Consequently, player devices 1618, 1620, and 1622 are able to provide the following respective further sub-shares s*_{1,5,7}=h_{7,5}(1), s*_{2,5,7}=h_{7,5}(2), and s*_{3,5,7}=h_{7,5}(3) to new player device 1612 from which new player device 1612 could determine the respective sub-share 1606 from which the further new player device 1604 could determine the respective share 1602 in the secret. Similarly, player devices 1616, 1620 and 1622 are able to provide the following respective further sub-shares s*_{2,6,7}=h_{7,6}(2), s*_{3,6,7}=h_{7,6}(3), and s*_{4,6,7}=h_{7,6}(4) to player device 1614 from which new player device 1614 could determine the respective sub-share 1608 from which player device 1604 could determine the respective share 1602 in the secret.

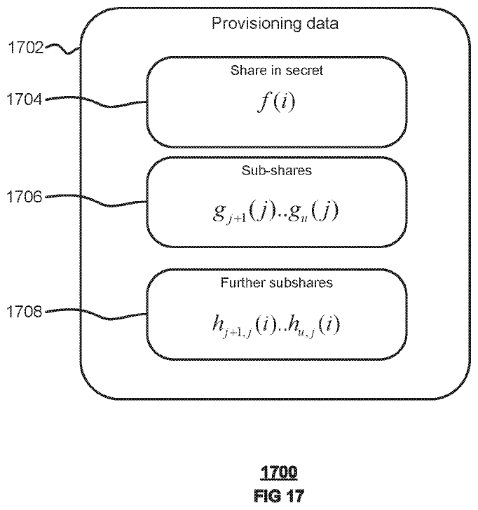

Referring to FIG. 17, there is shown a view 1700 of set 1702 of provisioning data issued to a set of n initial player devices such as, for example, the above set of n initial player devices 108 to 116. The set 1702 of provisioning data comprises a share 1704 in the secret, sets of sub-shares in the unassigned shares in the secret for new player devices and set of further sub-shares in the sub-shares in the unassigned shares in the secret for new player devices. Therefore, player device i would receive:
sᵢ, which is a share of the secret, SK, using polynomial notation, sᵢ=ƒ(i), that is kept for player device i,
the set {s′_{i,j}:n+1≤j≤u} that consists of shares of sᵢ with n+1≤j≤u, using polynomial notation, s′_{i,j}=gⱼ(i) such that player device i can send s′_{i,j}=gⱼ(i) to player device j and player device j can use s′_{i,j}=gⱼ(i) to facilitate computing ƒ(j), and
the set {s*_{i,j,k}:n+1≤j≤u; n+1≤k≤u} that consists of shares of s′_{i,j} with n+1≤j≤u and n+1≤k≤u using polynomial notation, s*_{i,j,k}=h_{k,j}(i) such that player device i can send s*_{i,j,k}=h_{k,j}(i) to player device j, player device j can use s*_{i,j,k}=h_{k,j}(i) to compute s′_{j,k}=gₖ(j) such that player device j can send s′_{j,k}=gₖ(j) to player device k to facilitate player device k computing ƒ(k).

It will be appreciated that if the shares ƒ(1), ƒ(2), . . . , ƒ(u) are issued in order then k will always be greater than j. Therefore, player device i could use the set {s*_{i,j,k}:n+1≤j<k≤u} rather than the set s*_{i,j,k}:n+1≤j≤u; n+1≤k≤u}.

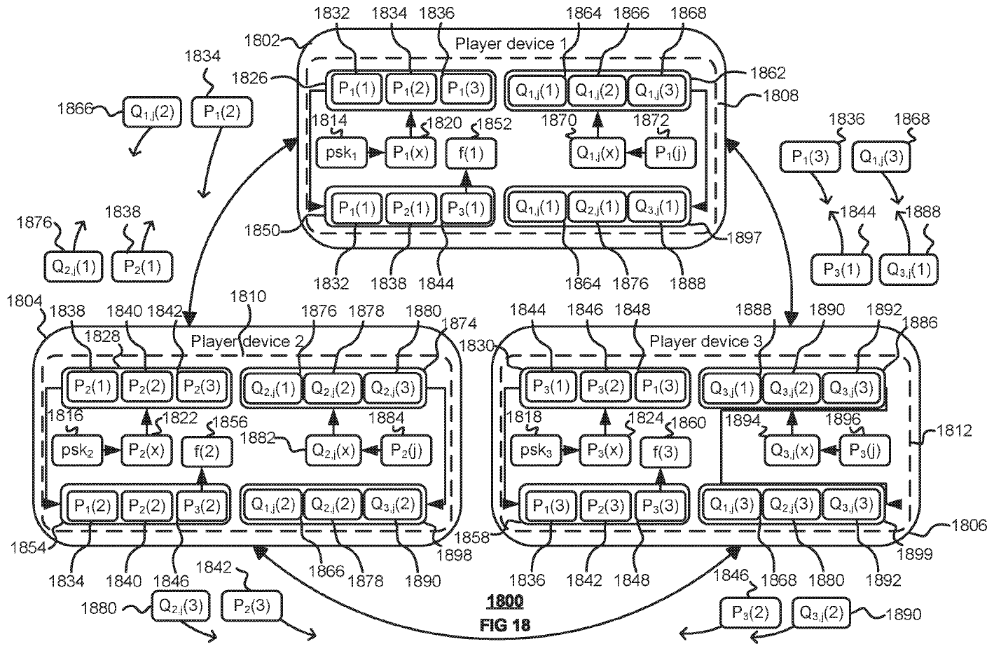

Referring to FIG. 18, there is shown a view 1800 of a system for generating and distributing shares in a secret in a decentralised manner. Example implementations will be described using three player devices 1802 to 1806. Example implementations are not limited to three player devices. Example implementations can be realised in which a number, u, of player devices are used. The system 1800 can operate as a (t,u) threshold system in which t player devices of a possible total number, u, of player devices can cooperate to use, recover, make available or otherwise issue a secret or use, recover or make available a share or shares in the secret. As initialised, the system 1800 will operate as a (t,n) threshold system, where n<u, in which t player devices of a current number, n, of player devices 1802 to 1806 can cooperate to use, recover, make available or otherwise issue a secret 1806.

Each player device 1802 to 1806 comprises a processor 1808 to 1812 arranged to implement player device functionality. Each player device 1820 to 1806 is arranged to generate a respective pre-secret key 1814 to 1818 and, using a respective generator polynomial 1820 to 1824 of the form Pᵢ(x)=Σⱼ₌₀^{t-1}α_{i,j}x^{j}, where 1≤i≤n, α_{i,0}=pskᵢ, α_{i,j}∈ [symbol] /m [symbol] are randomly chosen coefficients for j≥1, t is the threshold number of shares that can be used to issue or recover the pre-secret key, that is, α_{i,0}=pskᵢ, to generate respective sets 1826 to 1830 of shares in their respective pre-secret keys pskᵢ 1814 to 1818. Therefore, the set of shares 1826 in psk₁ 1814 comprises P₁(1) 1832, P₁(2) 1834, and P₁(3) 1836, the set of shares 1828 in psk₂ 1816 comprises P₂(1) 1838, P₂(2) 1840, and P₂(3) 1842, and the set of shares 1830 in psk₃ 1818 comprises P₃(1) 1844, P₃(2) 1846, and P₃(3) 1848.

Each player device 1802 to 1806 retains a predetermined share in their respective pre-secret key and distributes predetermined shares in their pre-secret key to the other player devices. In the distribution, an i^{th} player device receives i^{th} shares from the other player devices. Each i^{th} player distributes shares to the other player devices but retains their i^{th} share in their pre-secret key pskᵢ. Therefore, player device 1802 receives shares P₂(1) 1838 and P₃(1) 1844 from the other player devices 1804 and 1806 respectively, player device 1804 receives P1(2) 1834 and P₃(2) 1846 from the other player devices 1802 and 1806 respectively, and player device 1806 receives P₁(3) 1836 and P₂(3) 1842 from the other player devices 1802 and 1804 respectively. Consequently, each player device has a set of shares from which a respective share of the secret can be calculated. A j^{th} player device determines a respective share of the secret ƒ(j) from ƒ(j)=Σᵢ₌₁ⁿ Pᵢ (j). Therefore, player device 1802 has a set 1850 of respective shares P₁(1) 1832, P₂(1) 1838, and P₃(1) 1844 from which a respective share ƒ(1)=Σᵢ₌₁ⁿ Pᵢ (1) 1852 in the secret can be determined. Similarly, player device 1804 has a set 1854 of respective shares P₁(2) 1834, P₂(2) 1840, and P₃(2) 1846 from which a respective share ƒ(2)=Σᵢ₌₁ⁿ Pᵢ (2) 1856 in the secret can be determined. Also, player device 1806 has a set 1858 of respective shares P₁(3) 1836, P₂(3) 1842, and P₃(3) 1848 from which a respective share ƒ(3)=Σᵢ₌₁ⁿ Pᵢ (3) 1860 in the secret can be determined.

Once a threshold number t of player devices have respective shares in the secret, the player devices can cooperate to recover the secret or provide access the secret. Therefore, in the example implementation depicted in FIG. 18, assuming that the system implements a (2,n) threshold scheme, any two player devices of the three player devices 1802 to 1806 can cooperate to recover, that is, to provide access to the secret using their respective shares in the secret taken in pairs. It will be appreciated that there are several sets of shares in the secret that could be collaboratively used to recover the secret; namely, ƒ(1) & ƒ(2), ƒ(1) & ƒ(3), and ƒ(2) & ƒ(3).

Therefore, shares in a secret have been generated and distributed in a decentralised manner.

Furthermore, example implementations can be realised in which each player device 1802 to 1806 is additionally arranged to calculate respective future shares, Pᵢ(j) for n+1≤j≤u, (not shown) in the secret that can be distributed to new player devices Pⱼ in the future, where n+1≤j≤u. Each player device 1802 to 1806 is arranged to generate sub-shares in the respective future shares Pᵢ(j) using respective sub-share generator polynomials of the Q_{i,j}(x)=Σₖ₌₀^{t′-1}β_{i,j,k}x^{k}, where 1≤i≤n, β_{i,j,0}Pᵢ(j), β_{i,j,k}∈ [symbol] /m [symbol] are randomly chosen coefficients for all β_{i,j,k} but for β_{i,j,0}, t′ is the threshold number of shares that can be used to issue or recover a sub-share associated with the secret, that is, β_{i,j,0}=Pᵢ(j), where n+1≤j≤u. Therefore, for n+1≤j≤u each player device calculates n−1 sub-shares in each of Pᵢ(j), that is, each player device calculates a set of sub-shares {Q_{i,j}(1), . . . , Q_{i,j}(n−1)} and distributes respective sets of shares to respective player devices while retaining their own respective shares in each Pᵢ(j).

Therefore, player device 1802 generates a set 1862 of sets of sub-shares {Q_{1,j}(1), . . . , Q_{1,j}(n−1)} comprising Q_{1,j}(1) 1864, Q_{1,j}(2) 1866, and Q_{1,j}(3) 1868, using respective generator polynomials Q_{1,j}(x)=Σₖ₌₀^{t′-1}β_{1,j,k}x^{k} 1870 with future shares P₁(j) 1872 as respective secrets. Similarly, player device 1804 generates a set 1874 of sets of sub-shares {Q_{2,j}(1), . . . , Q_{2,j}(n−1)} comprising Q_{2,j}(1) 1876, Q_{2,j}(2) 1878, and Q_{2,j}(3) 1880, using respective generator polynomials Q_{2,j}(x)=Σₖ₌₀^{t′-1}β_{2,j,k}x^{k} 1882 with future shares P₂(j) 1884 as respective secrets. Also, player device 1806 generates a set 1886 of sets of sub-shares {Q_{3,j}(1), . . . , Q_{3,j}(n−1)} comprising Q_{3,j}(1) 1888, Q_{3,j}(2) 1890, and Q_{3,j}(3) 1892, using respective generator polynomials Q_{3,j}(x)=Σₖ₌₀^{t′-1}β_{3,j,k}x^{k} 1894 with future shares P₃(j) 1896 as respective secrets.

The player devices 1802 to 1806 distribute respective sub-shares {Q_{i,j}(1), . . . , Q_{i,j}(n−1)} to the other player devices. Therefore, player device 1802 distributes sets of sub-shares Q_{1,j}(2) 1866 and Q_{1,j}(3) 1868 to player devices 1804 and 1806 respectively, player device 1804 distributes sets of sub-shares Q_{2,j}(1) 1876 and Q_{2,j}(3) 1880 to player devices 1802 and 1806 respectively, and player device 1806 distributes sets of sub-shares Q_{3,j}(1) 1888 and Q_{3,j}(2) 1890 to player devices 1802 and 1804 respectively. Consequently, each of the player devices 1802 to 1806 comprises respective sets of sets of sub-shares 1897 to 1899.

Therefore, the player devices 1802 to 1806 can facilitate a new player device Pⱼ in accessing a respective share ƒ(j) in the secret. To facilitate access to the respective share ƒ(j), t′ player devices select the next hitherto unassigned share in order for new player device Pⱼ and, for 1≤i≤n, send respective sub-shares of Pᵢ(j) to new player device Pⱼ to allow the new player device to calculate ƒ(j)=Σᵢ₌₁ⁿPᵢ(j), that is, player device Pᵢ would send sub-shares {Q_{1,j}(i), . . . , Q_{n,j}(i)} to the new player device Pⱼ. Accordingly, the new player device Pⱼ will have been provisioned, by previously provisioned player devices such as the player devices 1802 to 1806, with a respective share ƒ(j) in the secret. Consequently, the new player device Pⱼ will be able to collaborate with t−1 other player devices in recovering the secret or in making the secret available to a further entity or in using its respective share.

In the example illustrated, player device 1802 would send the i^{th} set 1897 of sub-shares 1864, 1876, 1888, that is, {Q_{1,j}(1), . . . , Q_{n,j}(1)}, to a new player device j, where new player device was not part of the set of n initial player devices. Similarly, player device 1804 would send the i^{th} set 1989 of sub-shares 1866, 1878, 1890, that is, {Q_{1,j}(2), . . . , Q_{n,j}(2)}, to the new player device j, and player device 1806 would send the i^{th} set 1989 of sub-shares 1868, 1880, 1892, that is, {Q_{1,j}(3), . . . , Q_{n,j}(3)}, to the new player device j. The new player device j can determine respective shares {Pᵢ(j)} in a respective share ƒ(j) of the secret from ƒ(j)=Σᵢ₌₁ⁿPᵢ(j).

In the particular case of adding a fourth player device, that is, j=4, the fourth player device would receive from the other player devices 1802 to 1806 the following sets of sub-shares {Q_{1,4}(1), Q_{2,4}(1), Q_{3,4}(1)} 1897, {Q_{1,4}(2), Q_{2,4}(2), Q_{3,4}(2)} 1898, and {Q_{1,4}(3), Q_{2,4}(3), Q_{3,4}(3)} 1899 from which the fourth player device can calculate respective shares P₁(4), P₂(4), P₃(4) from {Q_{1,4}(1), Q_{1,4}(2), Q_{1,4}(3)} 1862, {Q_{2,4}(1), Q_{2,4}(2), Q_{2,4}(3)} 1874, and {Q_{3,4}(1), Q_{3,4}(2), Q_{3,4}(3)} 1886. In general, the i^{th} new player device will receive from the other player devices the sub-shares selected from the sets of sub-shares {Q_{1,j}(1), . . . , Q_{n,j}(2)} to {Q_{1,j}(n), . . . , Q_{n,j}(n)} from which the sets of sub-shares {Q_{1,j}(1), . . . , Q_{1,j}(n)} to {Q_{n,j}(1), . . . , Q_{n,j}(n)} can be determined from which, in turn, respective shares P₁(j) to Pₙ(j) can be determined so that a respective share ƒ(j) in the secret can be determined.

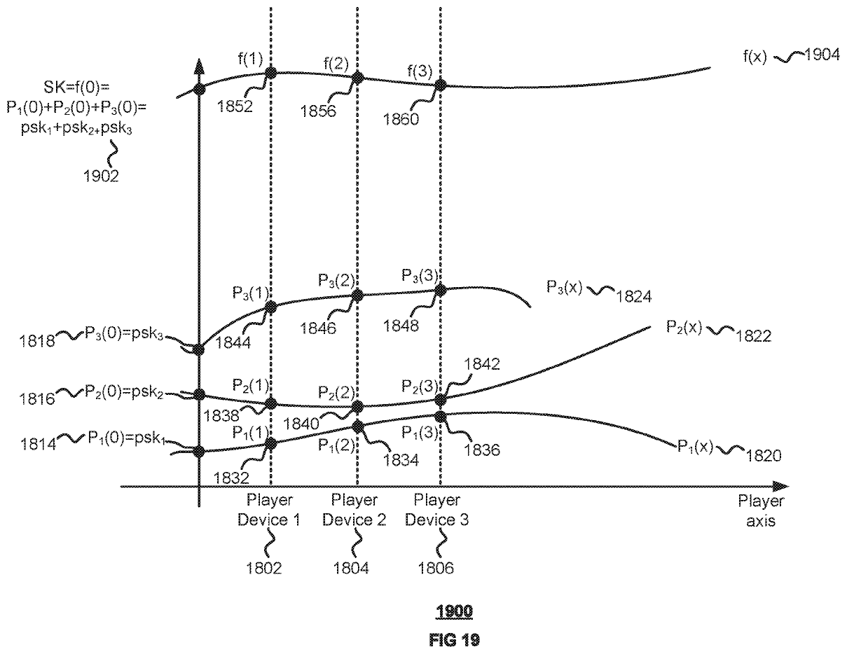

Referring to FIG. 19, there is shown a graphical view 1900 of the above processes for recovering or making available shares, ƒ(1) 1852, ƒ(2) 1856, ƒ(3) 1860, in the secret, SK, 1902 that have been derived from sub-shares, Pᵢ(j), 1≤i≤n; n+1≤j≤u in the shares ƒ(1) 1852, ƒ(2) 1856, ƒ(3) 1860 in the secret, SK, 1902.

Each player device receives respective sub-shares in the shares of the secret. Therefore, player device 1802 generated sub-share P₁(1) 1832 and received, respectively from player devices 1804 and 1806, sub-shares P₂(1) 1838 and P₃(1) 1844 from which a respective share ƒ(1)=Σᵢ₌₁ⁿPᵢ(1) 1852 in the secret 1902 can be calculated. Similarly, player device 1804 generated sub-share P₂(2) 1840 and received, respectively from player devices 1802 and 1806, sub-shares P₁(2) 1834 and P₃(2) 1846 from which a respective share ƒ(2)=Σᵢ₌₁ⁿPᵢ(2) 1856 can be calculated. Finally, player device 1806 generated sub-share P₃(3) 1848 and received, respectively from player devices 1802 and 1804, sub-shares P₁(3) 1836 and P₂(3) 1842 from which a respective share ƒ(3)=Σᵢ₌₁ⁿPᵢ(3) 1860 can be calculated.

Therefore, the secret 1902 can be recovered by any two of the player devices 1802 to 1808 providing respective shares ƒ(i) in the secret 1902 to a further entity, which can use those shares to determine the generator polynomial ƒ(x) 1904 used to generate the shares ƒ(i) in the secret 1902 from which the secret 1902 can be calculated as SK=ƒ(0), which will correspond to the SK=Σᵢ₌₁ⁿpskᵢ.

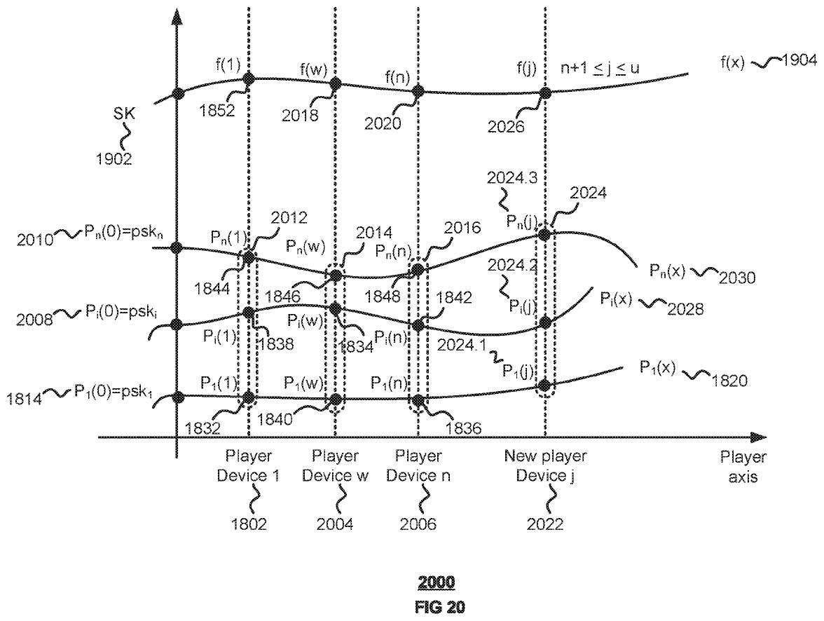

Referring to FIG. 20, there is shown a view 2000 of the general case of the graphical view 1900 of the above processes for recovering or making available from shares 1852, 1856, 1860 and 2002 in the secret 1902. Assuming that there are three layers of secret sharing and a set of n initial player devices 1802, 2004, 2006, each of then initial player devices receives a respective set of shares in each of the pre-secret keys 1814, 2008, 2010 such that the w^{th} player device generates and/or receives a set of shares {Pᵢ(w): 1≤i≤n} in each of the pre-secret keys 1814, 2008, 2010. Player device 1802 generates and/or receives a set of shares {P₁(1) . . . Pₙ(1)} 2012, that is, shares P₁(1) to Pₙ(1) in respective pre-secret keys psk₁ 1814 to pskₙ 2010. Player device 2004 generates and/or receives a set of shares {P₁(w) . . . Pₙ(w)} 2014, that is, shares P₁(w) to Pₙ(w) in respective pre-secret keys psk₁ 1814 to pskₙ 2010. Player device 2006 generates and/or receives a set of shares {P₁(n) . . . Pₙ(n)} 2016, that is, shares P₁(n) to Pₙ(n) in respective pre-secret keys psk₁ 1814 to pskₙ 2010.

The set of shares received allows a respective player device to generate a respective share in the secret. Therefore, the set of shares {P₁(1) . . . Pₙ(1)} 2012 enables player device 1802 to generate the respective share ƒ(1)=Σᵢ₌₁ⁿPᵢ(1) 1852 in the secret 1902. The set of shares {P₁(w) . . . Pₙ(w)} 2014 enables player device 2004 to generate the respective share ƒ(w)=Σᵢ₌₁ⁿ(w) 2018 in the secret 1902. The set of shares {P₁(n) . . . Pₙ(n)} 2016 enables player device 2006 to generate the respective share ƒ(n)=Σᵢ₌₁ⁿPᵢ(n) 2020 in the secret 1902.

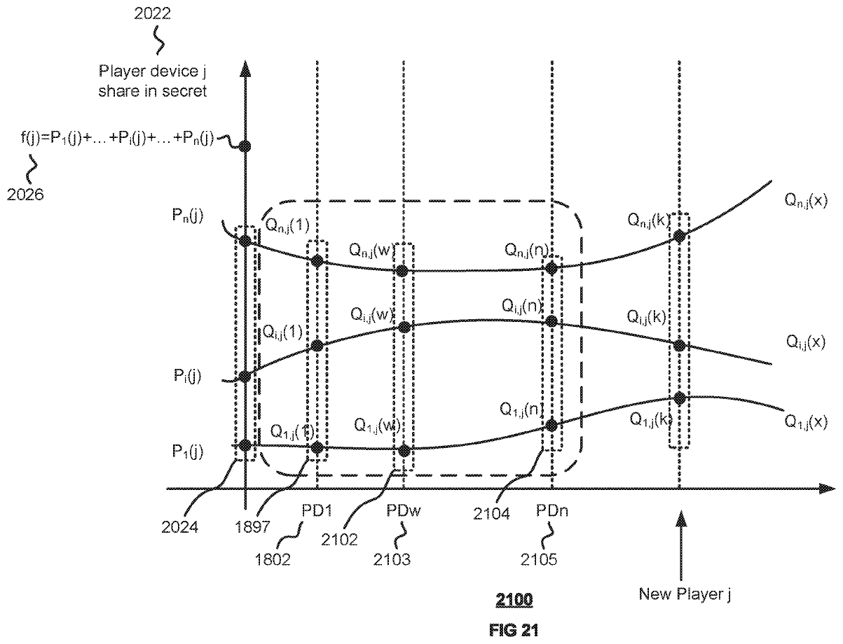

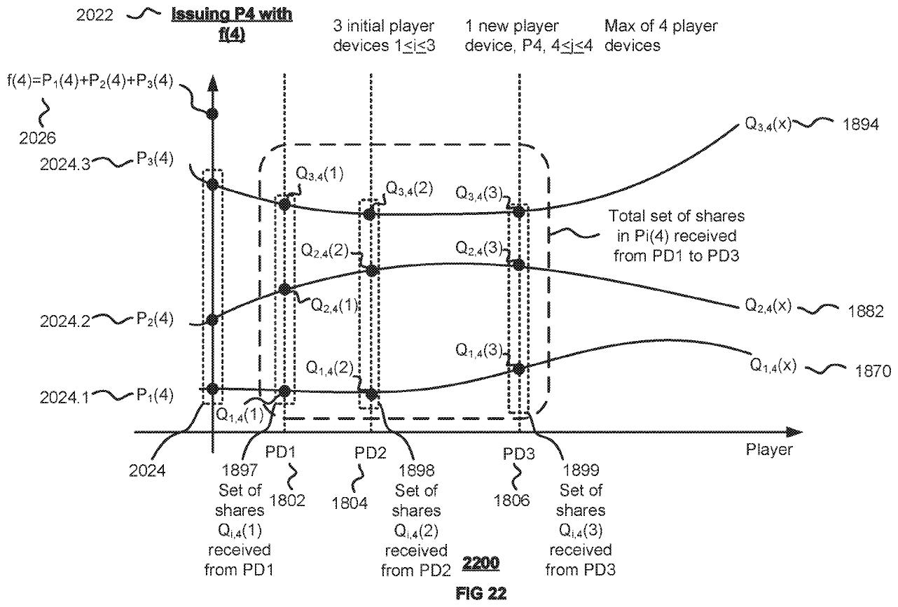

Similarly, a new player device 2022, not part of the set of n initial player devices can be assigned a respective set of shares {P₁(j) . . . Pₙ(j)} 2024 that enables player device 2022 to generate a respective share ƒ(j)=Σᵢ₌₁ⁿPᵢ(j) 2026 in the secret 1902. The process of assigning such a set shares {P₁(j) . . . Pₙ(j)} 2024 to enable player device 2022 to generate the respective share ƒ(j)=Σᵢ₌₁ⁿPᵢ(j) 2026 in the secret 1902 is illustrated in, and described below with reference to, FIGS. 21 and 22. The set shares {P₁(j) . . . Pₙ(j)} 2024 comprises shares P₁(j) 2024.1, . . . , Pᵢ(j) 2024.2, . . . , Pₙ(j) 2024.3.

A predetermined number, t, of collaborating player devices with respective shares 1852, 2018, 2020, 2026 in the secret 1902 can enable a further entity to recover the secret 1902 in the threshold scheme, which involves the further entity determining the generator polynomial ƒ(x) 1904 from which the secret 1902 can be calculate as SK=ƒ(0). Each of the shares in the pre-secret keys 1814, 2008, 2010 will have been generated by respective generator polynomials 1820, 2028, and 2030.

Referring to FIG. 21, there is shown a graphical view 2100 of the above processes for issuing a new share ƒ(j) 2026 to the new player device 2022 to enable the new player device 2022 to generate the respective share ƒ(j) 2026 in the secret 1902 that, in turn, allows the new player device to participate in recovering the secret 1902 or in making the secret 1902 available.

The new player device 2022 receives from the existing player devices respective sets of sub-shares {Q_{1,j}(1), . . . , Q_{i,j}(1), . . . , Q_{n,j}(1)} 1897, {Q_{i,j}(w), . . . Q_{i,j}(w), . . . , Q_{n,j}(w)} 2102, {Q_{1,j}(n), . . . , Q_{i,j}(n), . . . , Q_{n,j}(n)} 2104 associated with the respective share ƒ(j) 2026 in the secret 1902. In the illustrated example, the existing player devices are a set of n player devices {player device 1802, . . . , player device 2103, . . . , player device 2105}. The new player device 2022 uses the received sets of sub-shares 1897, 2102, 2104 to calculate the set 2024 of respective shares 2024.1, to 2024.3 in the respective share ƒ(j) 2026 in the secret.

Referring to FIG. 22, there is shown a view 2200 of the process of FIG. 21 applied in the case of a system for providing a fourth share in a secret to a fourth player device 2022; the system having a set of 3 initial player devices 1802 to 1806 as described above with reference to FIG. 18. Player device 1802 sends the set 1897 of sub-shares to the fourth player device 2022. Similarly, player device 1804 also sends the set 1898 of sub-shares to the fourth player device 2022. Additionally, player device 1806 sends the set 1899 of sub-shares to the fourth player device. The fourth player device 2022 receives the sets of sub-shares 1897 to 1899 and uses them to determine the shares P₁(4) to P₃(4) 2024.1 to 2024.3 in the respective share 2026 in the secret according to the threshold scheme set of each of the generator polynomials 1870, 1882, 1894.

Therefore, the above can be used to realise a decentralised system for distributing shares in a secret to new player devices such that the new player devices can use their respective shares in accessing the secret or otherwise making the secret available to another entity.

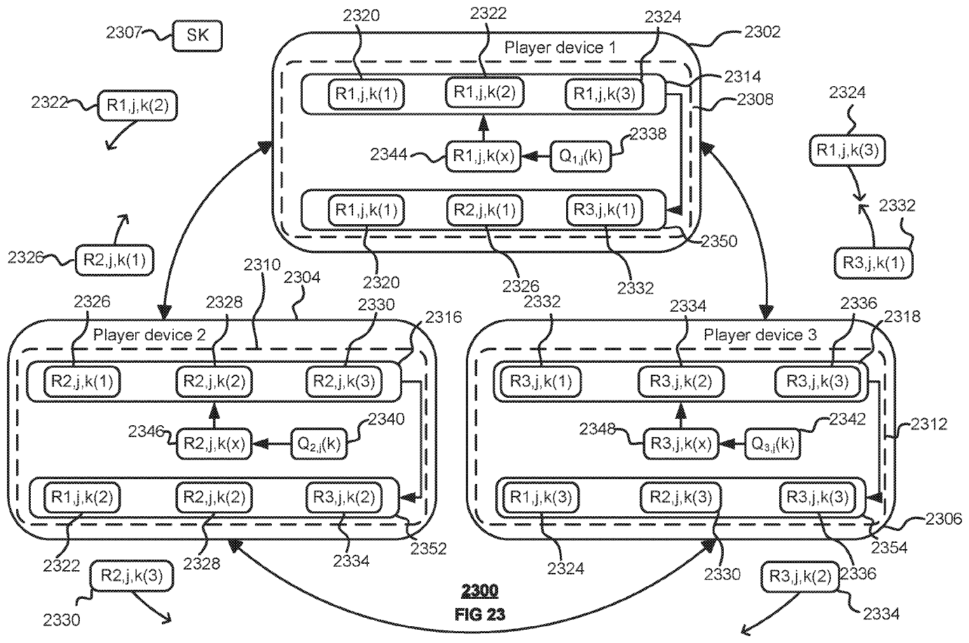

Referring to FIG. 23, there is shown a view 2300 of a system for generating and distributing shares in a decentralised manner, in particular for provisioning a new player device with shares to facilitate a further new player device access a share in a secret.

Example implementations will be described using three player devices 2302 to 2306. Example implementations are not limited to three player devices. Example implementations can be realised in which a predetermined number, n to u, n<u, player devices are used. The system 2300 operates as a (t*,n) threshold system in which t* player devices of the total number, n to u, of player devices 2302 to 2306 can cooperate to use, recover, make available or otherwise issue at least one, or both, of a share or shares in a secret 2307 or the secret 2307 per se. The shared secret 2307 is an example implementation of any of the above described shared secrets.

As initialised, the system 2300 will operate as a (t*,n) threshold system, where n<u, in which t* player devices of the total number, u, of player devices 2302 to 2306 can cooperate to use, recover, make available or otherwise issue a secret 2306. As new player devices are added, the system, as per all of the above systems, operates as a (t*, c) threshold system, where c is the current number of player devices given newly added player devices relative to the original number, n, of player devices, where n+1≤c≤u.

Each player device 2302 to 2306 comprises a processor 2308 to 2312 arranged to implement player device functionality. Each player device 2302 to 2306 is arranged to generate sets 2314 to 2318 of further sub-shares 2320 to 2336 in respective sets 2338 to 2342 of sub-shares, {Q_{i,j}(k): 1≤i≤n, n+1≤j≤u}, of respective shares {ƒ(i): 1≤i≤u} in the secret 2307.

Each set 2314 to 2318 of further sub-shares 2320 to 2336 is generated using respective generator polynomials 2344 to 2348 of the form R_{i,j,k}(x)=Σₗ₌₀^{t*-1}γ_{i,j,k,l}xⁱ, where 1≤i≤n, n+1≤j≤n, n+1≤k≤n, γ_{i,j,k,0}=Q_{i,j}(k), γ_{i,j,k,l}∈ [symbol] /m [symbol] are randomly chosen coefficients for l≥1, t* is the threshold number of shares that can be used to issue or recover the secrets, that is, γ_{i,j,k,0}=Q_{i,j}(k) to produce the respective sets 2314 to 2318 of the further shares in each of γ_{i,j,k,0}=Q_{i,j}(k).

Therefore, the sets of shares 2314 to 2318 in γ_{1,j,k,0}=Q_{i,j}(k) comprises the further sub-shares 2320 to 2336, that is, the sets of shares 2314 comprise R_{1,j,k}(1) 2320, R_{1,j,k}(2) 2322, R_{1,j,k}(3) 2324, the sets of shares 2316 in γ_{2,j,k,0}=Q_{2,j}(k) 2340 comprise R_{2,j,k}(1) 2326, R_{2,j,k}(2) 2328, R_{2,j,k}(3) 2330, and the sets of shares 2318 in γ_{3,j,k,0}=Q_{3,j}(k) 2342 comprise R_{3,j,k}(1) 2332, R_{3,j,k}(2) 2334, R_{3,j,k}(3) 2336.

Each player device 2302 to 2306 retains a predetermined share in their respective sets of further sub-shares and distributes predetermined sets of further sub-shares to the other player devices such that any given player device, that is, w^{th} player device, receives one share in each set Q_{i,j}(k) where 1≤i≤n, j>n, k≤u. Each player distributes such sets of shares to the other player devices but retains their w^{th} set of shares.

Therefore, player device 2302 receives sets of shares R_{2,j,k}(1) 2326 and R_{3,j,k}(1) 2332 from the other player devices 2304 and 2306 respectively to form the sets 2350 of further sub-shares 2320, 2326, 2332, player device 2304 receives R_{1,j,k}(2) 2322 and R_{3,J,k}(2) 2334 from the other player devices 2302 and 2306 respectively to form the sets 2352 of further sub-shares 2322, 2328, 2334, and player device 2306 receives R_{1,j,k}(3) 2324 and R_{2,j,k}(3) 2330 from the other player devices 2302 and 2304 respectively to form the sets 2354 of further sub-shares 2324, 2330, 2336. Consequently, each player device has sets of further sub-shares R_{i,j,k}(x) from which respective sub-shares Q_{i,j}(k) can be derived or provided to calculate respective sub-shares Pᵢ(j) from which respective shares ƒ(j) in the secret can be calculated.

Therefore, the player devices 2302 to 2306 can provision a new player device with respective sub-shares Q_{i,j}(k), via the further sub-shares 2320 to 2336 in the respective sets 2338 to 2342 of sub-shares, {Q_{i,j}(k): 1≤i≤n, n+1≤j≤u}, to provide shares Pᵢ(j) of respective shares ƒ(j) to facilitate a further new player device in accessing a respective share {ƒ(i): n+1≤i≤u} in the secret 2307. In any and all implementations, neither the new player device nor the further new player device form part of the set of n initial player devices.

Once the sets of further sub-shares R_{i,j,k}(x) have been appropriately distributed, each player device 2302 to 2306 forms a respective set of such sets of further sub-shares R_{i,j,k}(x) such as, for example, sets 2350 to 2354. Therefore, set 2350 comprises sets of further sub-shares R_{1,j,k}(1) 2320, R_{2,j,k}(1) 2326, R_{3,j,k}(1) 2332, set 2352 comprises sets of further sub-shares R_{1,j,k}(2) 2322, R_{2,j,k}(2) 2328, R_{3,j,k}(2) 2334, and set 2354 comprises sets of further sub-shares R_{1,j,k}(3) 2324, R_{2,j,k}(3) 2330, R_{3,j,k}(3) 2336.

Therefore, it can be appreciated that once a threshold number t* of player devices have respective sets 2350 to 2354 of further shares, R_{i,j,k}(x), associated with the secret, the player devices can cooperate to provide access to or otherwise provision the new player device to provide respective sets of sub-shares Q_{i,j}(k) to the further new player device to facilitate the further new player device in accessing shares, Pᵢ(j), in a respective share, ƒ(i), of the secret, which, in turn, enables the further new player device to participate in recovering or otherwise providing access to the secret.

It will be appreciated that, in the example implementation depicted in FIG. 23, assuming that the system implements a (2, n) threshold scheme, any two player devices of the three player devices 2302 to 2306 can cooperate to recover, access or provide access to the sets of sub-shares Q_{i,j}(k) via respective sets of further sub-shares R_{i,j,k}(x).

Therefore, the foregoing provisions new player devices to, in turn, provision further new player devices to access respective unassigned shares in a secret in a distributed or a decentralised manner.

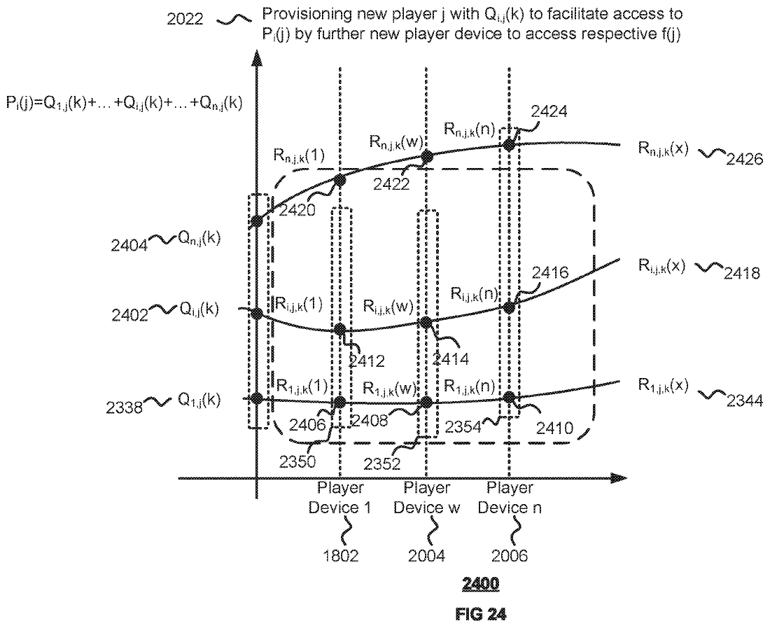

Referring to FIG. 24, there is shown a graphical view 2400 of the process depicted in and described with reference to FIG. 23 for provisioning a new player device with data to participate in making a share in the secret available to a further new player device.

The new player device 2022 receives from the existing player devices 1802, 2004, 2006 respective sets of further sub-shares {R_{1,j,k}(1),R_{2,j,k}(1),R_{3,j,k}(1)} 2350, {R_{1,j,k}(2),R_{2,j,k}(2), R_{3,j,k}(2)} 2352, {R_{1,j,k}(3), R_{2,j,k}(3), R_{3,j,k}(3)} 2354 to enable the new player device 2022 to access the respective sets of sub-shares Q_{i,j}(k) that can be provided to the further new player device so that the latter can access shares Pᵢ(j) in a respective share ƒ(j) 2026 in the secret 1902.

The new player device 2022 uses the received sets of further sub-shares 2350 to 2354 to reconstruct the original or initial sets of further sub-shares {R_{1,j,k}(1), R_{1,j,k}(2), R_{1,j,k}(3)} 2314, {R_{2,j,k}(1), R_{2,j,k}(2), R_{2,j,k}(3)} 2316, {R_{3,jk}(1), R_{3,j,k}(2), R_{3,j,k}(3)} 2318 from which the respective sets of sub-shares Q_{i,j}(k) 2338, Q_{2,j}(k) 2340, and Q_{3,j}(k) 2342 can be derived. The derived sets of sub-shares Q_{i,j}(k) 2338, Q_{2,j}(k) 2340, and Q_{3,j}(k) 2342 can be used to provide access to the further new player device to respective shares Pᵢ(j) 1872, 1884, 1896 in a respective share ƒ(j) in the secret 1902.

Therefore, it can be seen that the set of still further sub-shares {R_{1,j,k}(1), . . . , R_{1,j,k}(w), . . . , R_{1,j,k}(n)} can provide access to sets of further sub-shares Q_{1,j}(k) 2338. Similarly, the set of still further sub-shares {R_{i,j,k}(1), . . . , R_{i,j,k}(w), . . . , R_{i,j,k}(n)} can provide access to the sets of further sub-shares Q_{i,j}(k) 2402 and the set of still further sub-shares {R_{n,j,k}(1), . . . , R_{n,j,k}(w), . . . , R_{n,j,k}(n)} can provide access to the sets of further sub-shares Q_{n,j}(k) 2404.

The still further sub-shares {R_{1,j,k}(1) 2406, . . . , R_{i,j,k}(w) 2408, . . . , R_{i,j,k}(n) 2410} are associated with the respective generator polynomials 2344. The still further sub-shares {R_{i,j,k}(1) 2412, . . . , R_{i,j,k}(w) 2414, . . . , R_{i,j,k}(n) 2416} are associated with respective generator polynomials 2418. The still further sub-shares {R_{n,j,k}(1) 2420, . . . , R_{n,j,k}(w) 2422, . . . , R_{n,j,k}(n) 2424} are associated with respective generator polynomials 2426.

It can be seen that the further sub-shares {Q_{1,j}(k) 2338, . . . , Q_{i,j}(k) 2402, . . . , Q_{n,j}(k) 2404} can facilitate or otherwise enable access to sets of respective sub-shares Pᵢ(j) 1872, 1884, 1896 in a respective share ƒ(j) in the secret 1902.

Therefore, a new player device can be provisioned to assist a further new player device to access a respective share of the further new player device in the secret.

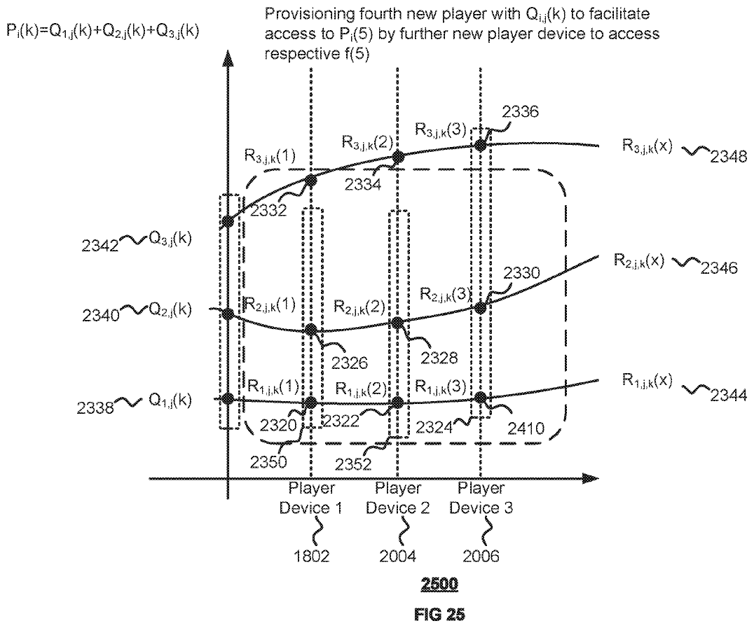

Referring to FIG. 25, there is shown a view 2500 of the process of FIG. 21 applied in the case of a system for provisioning a fourth player device to facilitate access by a further player device to a share in the secret.

It can be appreciated that the still further sub-shares {R_{1,j,k}(1) 2320, R_{1,j,k}(2) 2322, R_{1,j,k}(3) 2324} are associated with the respective generator polynomials R_{1,j,k}(x) 2344 and are arranged to provide access to sets of further sub-shares Q_{i,j}(k) 2338. The still further sub-shares {R_{2,j,k}(1) 2326, R_{2,j,k}(2) 2328, R_{2,j,k}(3) 2330} are associated with respective generator polynomials R_{2,j,k}(1) 2346 and are arranged to provide access to sets of further sub-shares Q_{2,j}(k) 2340. The still further sub-shares {R_{3,j,k}(1) 2332, R_{3,j,k}(2) 2334, R_{3,j,k}(3) 2336} are associated with respective generator polynomials R_{3,j,k}(1) 2348 and are arranged to provide access to sets of further sub-shares Q_{3,j}(k) 2342.

Although the example implementations shown in and described with reference to FIGS. 18 and 23 have been shown and described separately, example implementations can be realised in which they are combined, and the separate depictions and descriptions were intended to enable a simpler description to be realised to aid understanding.

Therefore, the above can be used to realise a decentralised system for distributing shares in a secret to new player devices such that the new player devices can use their respective shares in accessing the secret or otherwise making the secret available to another entity.

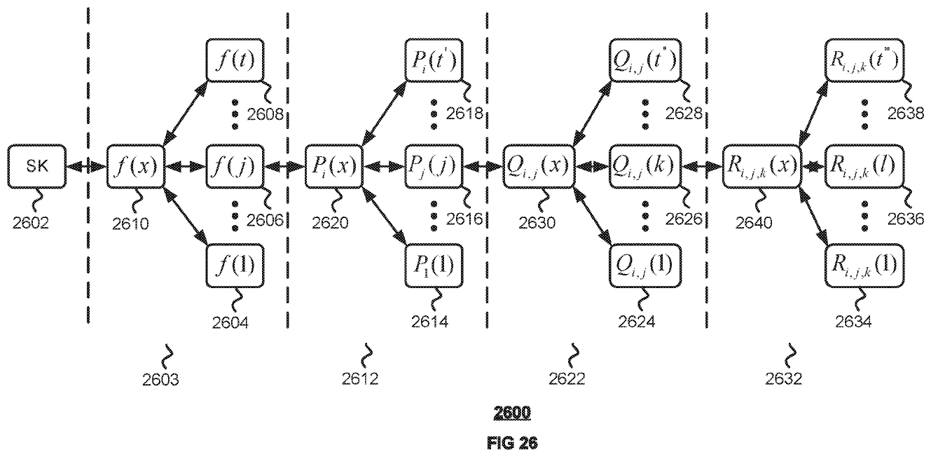

Referring to FIG. 26, there is shown a view 2600 of the hierarchical or layered structure to distributing shares in secret 2602 according to example implementations. The secret 2602 is an example implementation of any of the above described secrets.

It can be appreciated that the secret 2602 has a layer 2603 of associated shares ƒ(1) 2604 to ƒ(t) 2608 including a i^{th} share ƒ(j) 2606. In general, a share is related to the secret 2602 or derived from the secret 2602 via a generator polynomial 2610. In the example implementation depicted in FIG. 26, the generator polynomial has the form ƒ(x)=Σᵢ₌₀^{t-1}αᵢxⁱ+SK, where αᵢ∈ [symbol] /m [symbol] are randomly chosen coefficients and t is the threshold number of shares to use or recover SK.

To facilitate providing access to the first generation shares ƒ(1) 2604 to ƒ(t) 2608, a layer 2612 of sub-shares can be established for each share ƒ(1) 2604 to ƒ(t) 2608, or for a sub-set of those shares ƒ(1) 2604 to ƒ(t) 2608. The above described set 122 of unassigned shares is an example implementation of such a subset of shares. In the example illustrated, shares P₁(j) 2614, . . . , Pᵢ(j) 2616, . . . , Pₙ(j) 2618 in or derived from the i^{th} share ƒ(j) 2606 are shown. The shares P₁(j) 2614, . . . , Pᵢ(j) 2616, 2618 can be established using an associated generator polynomial Pᵢ(x) 2620 such as, for example, Pᵢ(x)=Σⱼ₌₀^{t′-1}αᵢxⁱ, where αⱼ∈ [symbol] /m [symbol] , j≥1, are randomly chosen coefficients, α₀=ƒ(j) and t′ is the threshold number of shares to use or recover the respective share ƒ(j) 2606. One or more player devices possessing the shares P₁(j) 2614, . . . , Pᵢ(j) 2616, . . . , Pₙ(j) 2618 in share ƒ(j) 2606 can make ƒ(j) 2606 available to a new player device by providing the threshold number, t′, of shares selected from the shares P₁(j) 2614, . . . , Pᵢ(j) 2616, . . . , Pₙ(j) 2618.

The above process of deriving shares in shares can be repeated so that player devices provisioned with a given layer of shares can make a preceding layer of shares available to a succeeding player device. In this way, the above described new player device can be provisioned to facilitate access by the further player device to respective shares to provide access to, or to facilitate access to, the secret.

Therefore, it can be appreciated that all, or a subset, of the shares 2614 to 2618 can be divided into, or have derived therefrom, a layer 2622 of respective further sub-shares 2624 to 2628 that can facilitate providing access to the respective sub-share 2616. In the illustrated example, the layer 2622 of further sub-shares, or sets of sub-shares, comprises shares Q_{i,j}(1) 2624, . . . , Q_{i,j}(x) 2626, . . . , Q_{i,j}(t*) 2628 in or derived from Pᵢ(j) 2616. The further sub-shares Q_{i,j}(1) 2624, . . . , Q_{i,j}(x) 2626, . . . , Q_{i,j}(C) 2628 can be established using a respective generator polynomial Q_{i,j}(x) 2630 that can take the form Q_{i,j}(x)=Σₖ₌₀^{t″-1}β_{i,j,k}x^{k} where β_{i,j,k}∈ [symbol] /m [symbol] , k≥1, are randomly chosen coefficients, β_{i,j,0}=Pᵢ(j) and t″ is the threshold number of shares to use or recover the respective share Pᵢ(j) 2616 from such a threshold number of shares in Pᵢ(j) 2616.

To enable a given layer of shares being available to provision a later added player device, existing or earlier player devices can be provisioned with later generation shares. Suitably, each additional layer of shares is arranged to provision a newly added player device to facilitate a further newly added player device to access shares in, or shares associated with or otherwise derived from other generation shares.

The number of layers of shares can be increased. Accordingly, the example illustrated in FIG. 26, comprises a further layer 2632 of still further sub-shares in one or more than one of the shares of the preceding layer 2622 of shares 2624 to 2628. In the illustrated example, the layer 2632 of still further sub-shares comprises shares R_{i,j,k}(1) 2634, . . . , R_{i,j,k}(l) 2636, . . . , R_{i,j,k}(t′″) 2638. The still further sub-shares k_{i,j,k}(1) 2634, . . . , R_{i,j,k}(l) 2636, . . . , R_{i,j,k}(t′″) 2638 can be established using a respective generator polynomial R_{i,j,k}(x) 2640 that can take the form R_{i,j,k}(x)=Σₗ₌₀^{t′″}γ_{i,j,k,l}x^{l} where γ_{i,j,k,l}∈ [symbol] /m [symbol] , l≥1, are randomly chosen coefficients, γ_{i,j,k,0}=Q_{i,j}(k) and t′″ is the threshold number of shares to use or recover the respective share Q_{i,j}(k) 2626 from such a threshold number of shares in Q_{i,j}(k) 2626.

Example implementations can be realised that repeatedly add layers of shares using respective generator polynomials per preceding layer of share together with a threshold number of participating shares to use or recover a respective preceding layer share.

Therefore, the set of n initial player devices are provisioned with the shares in multiple layers according to how many new player devices can be added to the set of n initial player devices, that is, according to the difference between n and u. Assuming three layers of shares and a set of n initial player devices, each of the n initial player devices is provisioned as follows such that player device w would receive:
1. the set {Pᵢ(w): 1≤i≤n}, that is, one share of each pre-secret key, the shares in the set {Pᵢ(w): 1≤i≤n} can be combined to make a share of SK;
2. the set {Q_{i,j}(w): 1≤i≤n; n+1≤j≤u}, where Q_{i,j}(x)=Σₖ₌₀^{t′-1}β_{i,j,k}x^{k} where β_{i,j,k}∈ [symbol] /m [symbol] , k≥1, are randomly chosen coefficients, β_{i,j,0}=Pᵢ(w) and t′ is the threshold number of shares to use or recover the respective share Pᵢ(w), that is, one share of each of Pᵢ(j) for 1≤i≤n and n+1≤j≤u, where the subset {Q_{i,j}(w): 1≤i≤n and j is previously unassigned} can be given to a new player device, that is, player device j, when they join the existing set of previously provisioned, or previous, player devices. With similar subsets from t′ player devices, the new player device can recover Pᵢ(j) for 1≤i≤n from which the new player device can recover a share in SK; and
3. the set {R_{i,j,k}(w): 1≤i≤n, n+1≤j≤u, n+1≤k≤u}, where R_{i,j,k}(x)=Σₗ₌₀^{t′″}γ_{i,j,k,l}xₗ where γ_{i,j,k,l}∈ [symbol] /m [symbol] , l≥1, are randomly chosen coefficients, γ_{i,j,k,0}=Q_{i,j}(k) and t′″ is the threshold number of shares to use or recover the respective share Q_{i,j}(k), that is, player device w has one share of each Q_{i,j}(k) for 1≤i≤n, n<j, k≤u.

The set {R_{i,j,k}(w): 1≤i≤n, k<j≤u and k is previously unassigned} can be given to a new player device, that is, player device k, when that player device joins the existing set of previously provisioned player devices. Therefore, with such sets from t′″ player devices, the new player device can recover Q_{i,j}(k) for 1≤i≤n, k<j≤u.

Accordingly, in turn, the set {Q_{i,j}(w): 1≤i≤n and j is previously unassigned} can be given to a new player, j, when they join the existing set of player devices. With comparable sets from t′ player devices, the new player device can recover Pᵢ(j) for 1≤i≤n from which the new player device can recover a share in SK.

Referring to FIG. 27, there is shown a flow chart 2700 for implementing the above according to example implementations.

At 2702, shares {Pᵢ(w): 1≤i≤n} in each pre-secret key are at least one, or both, of generated or received. One or more of the shares {Pᵢ(w): 1≤i≤n} in each pre-secret can be at least one, or both, of generated by a player device or received from another player device. The shares {Pᵢ(w): 1≤i≤n} can be used to calculate a share in the secret or output to a new player device to be used to calculate a share in the secret.

At 2704, shares {Pᵢ(w): 1≤i≤n; n+1≤j≤u} are at least one, or both, of generated and received. One or more of each of the shares {Q_{i,j}(w): 1≤i≤n; n+1≤j≤u} can be at least one, or both, of generated by a player device or received from another player device. The shares {Q_{i,j}(w): 1≤i≤n; n+1≤j≤u} can be used to calculate sub-shares Pᵢ(j) or output to a new player device to be used to calculate Pᵢ(j).

At 2706, shares {R_{i,j,k}(w): 1≤i≤n; n+1≤j≤u, n≤k≤u} are at least one, or both, of generated and received. One or more of each of the shares {R_{i,j,k}(w): 1≤i≤n; n+1 j≤u, n≤k≤u} can be at least one, or both, of generated by a player device or received from another player device. The shares {R_{i,j,k}(w): 1≤i≤n; n+1≤j≤u, n<k≤u} can be used to calculate further sub-shares Q_{i,j}(k) or output to a new player device to be used to calculate Q_{i,j}(k).

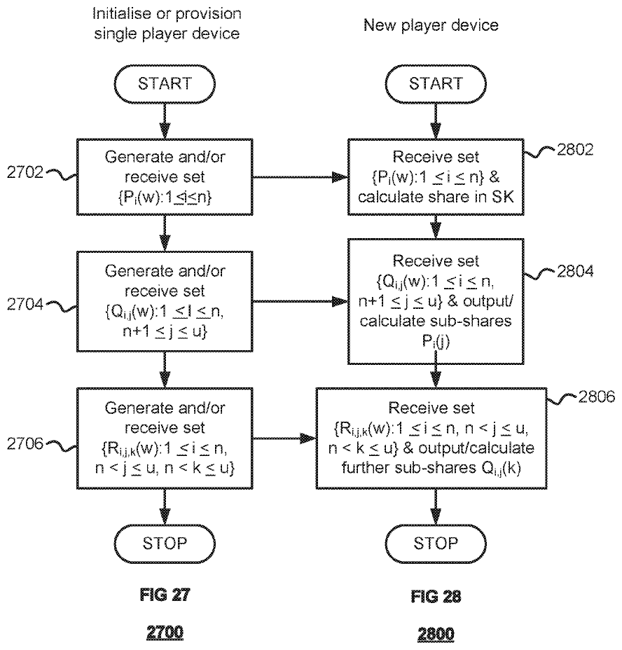

Referring to FIG. 28, there is shown a flow chart 2800 for implementing the above according to example implementations.

At 2802, the shares {Pᵢ(w): 1≤i≤n} in each pre-secret key are received. The received shares {Pᵢ(w): 1≤i≤n} in each pre-secret can be received from another player device. The received shares {Pᵢ(w): 1≤i≤n} can be used to calculate a share in the secret SK.

At 2804, the shares {Q_{i,j}(w): 1≤i≤n; n+1≤j≤u} are received. The received shares {Q_{i,j}(w): 1≤i≤n; n+1≤j≤u} can be received from another player device. The received shares {Q_{i,j}(w): 1≤i≤n; n+1≤j≤u} can be used to calculate sub-shares Pᵢ(j) to be used to calculate a share in the secret or to be output to another player device to be used to calculate a share in the secret.

At 2806, the shares {R_{i,j,k}(w): 1≤i≤n; n+1≤j≤u, n≤k≤u} are received. The received shares {R_{i,j,k}(w): 1≤i≤n; n+1≤j≤u, n<k≤u} can be received from another player device. The received shares {R_{i,j,k}(w): 1≤i≤n; n+1≤j≤u, n≤k≤u} can be used to calculate further sub-shares Q_{i,j}(k) or output to a further new player device to be used to calculate Q_{i,j}(k).

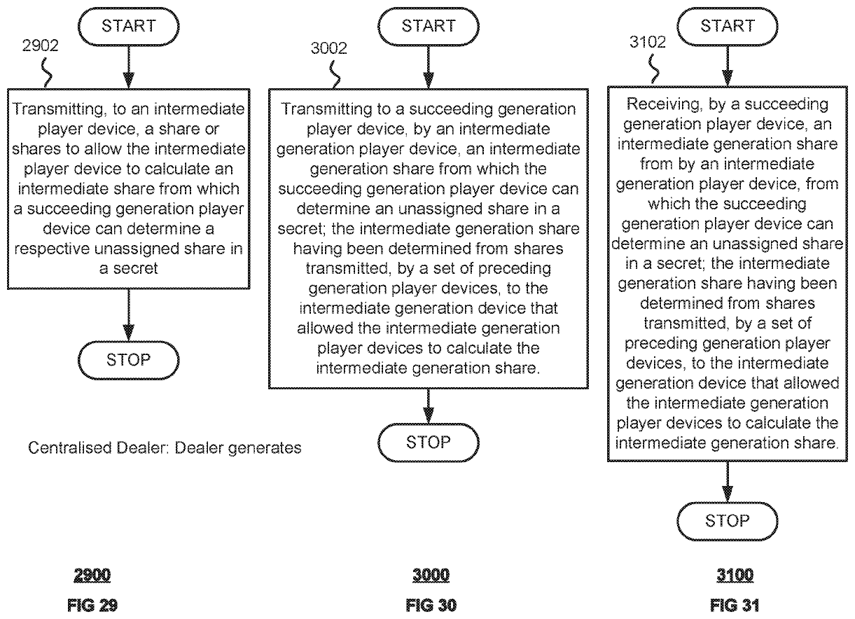

Referring to FIG. 29, there is shown a flow chart 2900 for provisioning a new player device to facilitate issuing a share to a further new player device. The new player device can be any of the new player devices described herein such as, for example, new player device 106. The further new player device can be any of the further new player devices described herein such as, for example, new player device 109.

At 2902, an entity transmits to a player device, a share, shares or sets of shares to allow the player device to calculate a share, shares or sets of shares respectively from which a subsequent generation player device can determine a respective unassigned share in a secret. The secret can be any secret described herein or a share, shares, or sets of shares associated with or otherwise derived from such a secret.

The entity can be a centralised dealer as described above or a player device of the set of n initial player devices 108 to 116 of a decentralised system.

Therefore, a new player device that was not one of the set of n initial player devices can be provisioned or otherwise initialised to issue shares to subsequent player devices.

Referring to FIG. 30, there is shown a flow chart 3000 for a previously or newly provisioned player device issuing an unassigned share in a secret to a new player device, that is, a succeeding or subsequent player device. At 3002, an intermediate player device, that is, a previously provisioned player device, transmits to a succeeding generation player device, that is, a subsequent new player device, or subsequent or succeeding generation player device, an intermediate generation share from which the succeeding generation player device can determine the hitherto unassigned share in the secret; the intermediate generation share having been determined from shares transmitted, by a set of preceding generation player devices, to the intermediate generation player device to facilitate the intermediate generation player device in determining the intermediate generation share.

Consequently, a new player device can be provisioned by existing or previously provisioned player devices to facilitate a further or subsequent new player device in accessing a respective share in a secret.

Referring to FIG. 31, there is shown a flow chart 3100 for the further new player device, that is, a succeeding generation or subsequent player device, accessing a respective hitherto unassigned share. At 3102, the further new player device receives an intermediate generation share from an intermediate generation player device, from which the further new player device can determine the hitherto unassigned share in a secret; the intermediate generation share having been determined from shares transmitted, by a set of preceding generation player devices, to the intermediate generation device that allowed the intermediate generation player device to calculate the intermediate generation share.

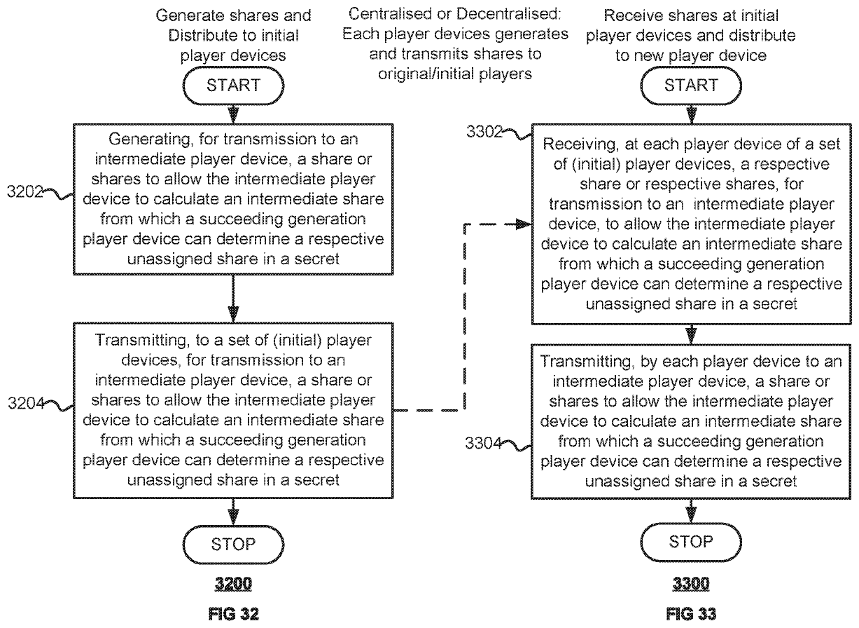

Referring to FIG. 32, there is shown a flow chart 3200 for provisioning the set of initial player devices 108 to 116 for provisioning or initialising a new player device to facilitate a further new player device in accessing a respective share in a secret for that further new player device.

At 3202, an entity generates, for transmission to an intermediate player device, a share, shares or set or sets of shares to allow the intermediate player device to calculate an intermediate share from which a succeeding generation player device can determine a respective hitherto unassigned share in a secret for the succeeding generation player device. The entity can be a centralised dealer system or a player device of the set of n initial player devices of a decentralised system.

At 3204, the entity transmits, to the set of n initial player devices or to the other (n−1) player devices of the set of n initial player devices, for transmission to an intermediate player device, a share, shares or set or sets of shares to allow the intermediate player device to calculate an intermediate share from which a succeeding generation player device can determine the respective hitherto unassigned share in the secret.

Referring to FIG. 33, there is shown a flow chart 3300 for provisioning the set of n initial player devices to enable an intermediate player device to facilitate a succeeding generation player device in accessing the respective share in the secret.

At 3302, the set of n initial player devices, receive the respective share, shares or sets of shares, for transmission to the intermediate player device, to allow the intermediate player device to calculate an intermediate share from which the succeeding generation player device can determine the respective hitherto unassigned share in a secret.

At 3304, a threshold number of player devices or the set of n initial player devices, transmits, to the intermediate player device, a respective share, shares, or set or sets of shares to allow the intermediate player device to calculate the intermediate share from which the succeeding generation player device can determine the respective hitherto unassigned share in a secret.

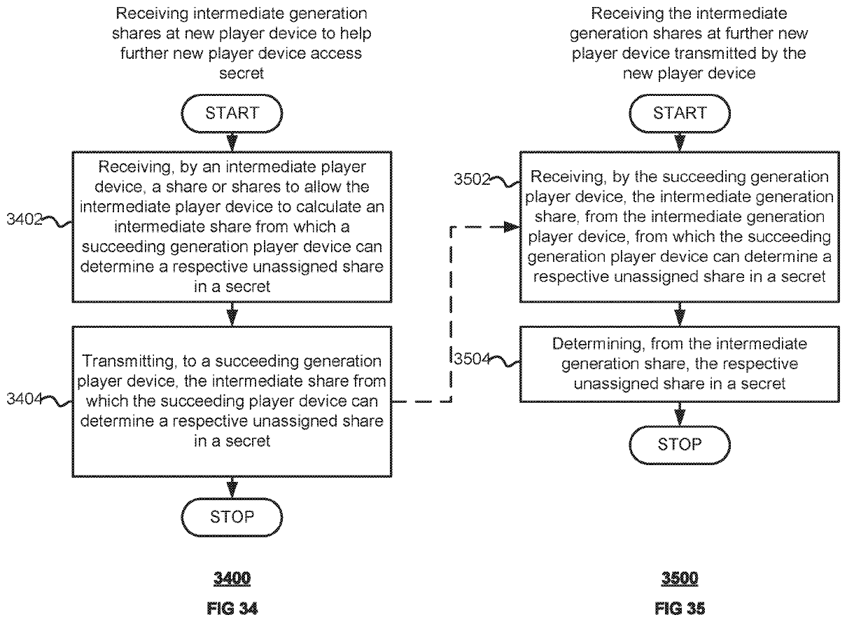

Referring to FIG. 34, there is shown a flow chart 3400 for issuing the intermediate generation share to the intermediate generation player device.

At 3402, the intermediate generation player device, receives the respective share, shares or set or sets of shares to allow the intermediate player device to calculate the intermediate share from which the succeeding generation player device can determine the respective hitherto unassigned share in a secret.

At 3404, the new player device, that is, the intermediate generation player device, transmits, to the succeeding generation player device, that is, the further new player device, the intermediate share from which the succeeding player device can determine the respective hitherto unassigned share in a secret.

Referring to FIG. 35, there is shown a flow chart 3500 from which the further new player device, that is, the succeeding generation player device accesses the hitherto unassigned respective share in the secret.

At 3502, the further new generation player device, that is, the succeeding generation player device, receives the intermediate generation share, from the intermediate generation player device, from which the succeeding generation player device can determine the respective hitherto unassigned share in the secret.

At 3504, the further new generation player device determines, from the intermediate generation share, the respective hitherto unassigned share in a secret.

Example implementations can be realised that provide machine-readable storage storing instructions arranged, when processed or implemented, to realise the methods, the flow charts, devices, or systems depicted and/or described herein.

Although the example implementations have been described with reference to the threshold number of player devices being three, example implementations are not limited to such arrangements. Example implementations can be realised in which the polynomials can have respective degrees of 2 or more.

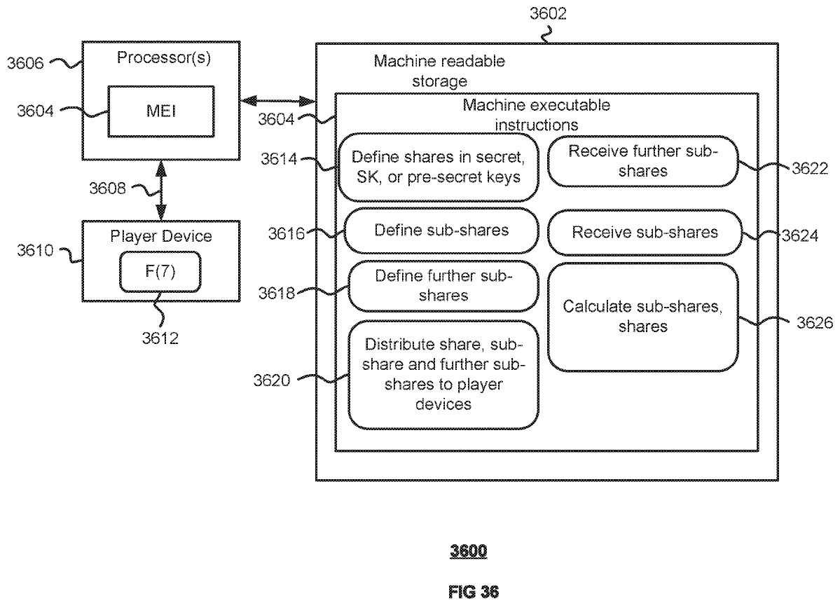

Referring to FIG. 36, there is illustrated machine-readable storage and machine-executable instructions according to example implementations.

It will be appreciated that circuitry as used herein can comprise any of physical electronic circuitry, software (such as machine-readable and machine-executable instructions), hardware, application specific integrated circuitry, or the like, taken jointly or severally in any and all permutations.

Therefore, implementations also provide machine-readable storage storing such machine-executable instructions. The machine-readable storage can comprise transitory or non-transitory machine-readable storage. The machine can comprise one or more processors, or other circuitry, for executing the instructions, implementing the instructions, interpreting the instructions or otherwise processing the instructions.

Accordingly, referring to FIG. 36, there is shown a view 3600 of implementations of at least one of machine-executable instructions or machine-readable storage. FIG. 36 shows machine-readable storage 3602. The machine-readable storage 3602 can be realised using any type of volatile or non-volatile storage such as, for example, memory, a ROM, RAM, EEPROM, or other electrical storage, or magnetic or optical storage or the like. The machine-readable storage 3602 can be transitory or non-transitory. The machine-readable storage 3602 stores machine-executable instructions (MEIs) 3604. The MEIs 3604 comprise instructions that are executable by a processor or other instruction execution, or instruction implementation, circuitry 3606. The processor or other circuitry 3606 is responsive to executing or implementing the MEIs 3604 to perform any and all activities, operations, or methods described and/or claimed in this application such as the operations described with reference to at least one or more of FIGS. 1 to 35.

The processor or other circuitry 3606 can output one or more than message or signal 3608 to a player device 3610. The player device 3610 can be an example implementation of any of the player devices described herein.

The MEIs 3604 can comprise MEIs to implement any flow chart described herein or any part thereof taken jointly and severally with any other part thereof, and/or any method described herein.

The machine executable instructions 3604 comprise instructions arranged, when processed or implemented, to realise any and all systems, methods, player devices, dealers described and/or depicted in this application.

The MEIs 3604 comprise instructions 3614 for defining shares in a secret, or for defining initial pre-secret keys from which the secret can be constructed in a decentralised manner. The secret can be any secret described herein.

The MEIs 3604 comprise instructions 3616 to define sub-shares in the shares. The sub-shares can be any of the sub-shares described herein. The MEIs 3618 define further sub-shares in the sub-shares of the secret. The further sub-shares can be any of the sub-shares described herein.

The MEIs comprise instructions 3620 to distribute the shares, sub-shares and further sub-shares to the player devices, including the set of n initial player devices and any additional player devices that are added to the set of n initial player devices such as, for example, the above described new player device, the further new player device and the still further new player device.

The MEIs comprise instructions 3622 for receiving the further sub-shares to determine therefrom respective sub-shares.

The MEIs comprise instructions 3624 for receiving the sub-shares to determine therefrom respective shares in the secret.

In the implementation depicted in FIG. 36, it can be seen that the player device 3610 has been issued with share ƒ(7) in the secret.

Accordingly, example implementations provide machine-readable storage storing instructions, arranged when processed by a processor, to issue an unassigned share ƒ(7) 1406B to a succeeding generation player device 1404B, the instructions comprising: instructions for a set of preceding generation player devices P1 . . . P5 1412B providing, to an intermediate generation player device P6 1402B, shares such as, for example, preceding generation shares 1414B, to allow the intermediate generation player device P6 1402B to calculate an intermediate generation share s′₆₇=g₇(6) 1416B from which the succeeding generation player device P7 1404B, together with a set 1421B of other intermediate generation shares s′₁₇=g₇(1) . . . s′₅₇=g₇(5) 1422B to 1430B provided by respective other intermediate generation player devices P1 . . . P5 1421, can calculate the unassigned share g₇(0)=s₇=ƒ(7) 1406B; and instructions for the intermediate generation player device P6 1402B and the set 1421B of other intermediate generation player devices providing the intermediate generation share 1416B and the set of the other intermediate generation shares s′₁₇=g₇(1) . . . s′₅₇=g₇(5) 1422B to 1430B to the succeeding generation player device P7 1404B.

Accordingly, example implementations provide a computer implemented method for accessing an unassigned share ƒ(7) 1406B by a succeeding generation player device P7 1404B, the method comprising: receiving, from an intermediate generation player device P6 1402B, an intermediate generation share s′₆₇=g₇(6) 1416B, the intermediate generation share s′₆₇=g₇(6) 1416B being arranged to facilitate access to the unassigned share f(7) 1406B and the intermediate generation share s′₆₇=g₇(6) 1416B having been derived from shares, such as, for example, preceding generation shares, provided by a set of preceding generation player devices P1 . . . P5 1412B; receiving, from a set of other intermediate generation player devices P1 . . . P5 1421B, a set of other intermediate generation shares s′₁₇=g₇(1) . . . s′₅₇=g₇(5) 1422B to 1430B, to facilitate access by the succeeding generation player device P(7) 1404B to the unassigned share g₇(0)=s₇=ƒ(7) 1406B in conjunction with the intermediate generation share s′₆₇=g₇(6) 1416B; and accessing the unassigned share g₇(0)=s₇=ƒ(7) 1406B using the intermediate generation share s′₆₇=g₇(6) 1416B and the set 1420B of other intermediate generation shares s′₁₇=g₇(1) . . . s′₅₇=g₇(5) 1422B to 1430B.

Accordingly, example implementations provide a machine readable storage storing instructions arranged, when processed by a processor, for accessing an unassigned share ƒ(7) 1406B by a succeeding generation player device P7 1404B, the instructions comprising: instructions to receive, from an intermediate generation player device P6 1402B, an intermediate generation share s′₆₇=g₇(6) 1416B, the intermediate generation share s′₆₇=g₇(6) 1416B being arranged to facilitate access to the unassigned share ƒ(7) 1406B and the intermediate generation share s′₆₇=g₇(6) 1416B having been derived from preceding generation shares provided by a set of preceding generation player devices P1 . . . P5 1412B; instructions to receive, from a set of other intermediate generation player devices P1 . . . P5 1421B, a set of other intermediate generation shares s′₁₇=g₇(1) . . . s′₅₇=g₇(5) 1422B to 1430B, to facilitate access by the succeeding generation player device P(7) 1404B to the unassigned share g₇(0)=s₇=ƒ(7) 1406B in conjunction with the intermediate generation share s′₆₇=g₇(6) 1416B; and instructions to access the unassigned share g₇(0)=s₇=ƒ(7) 1406B using the intermediate generation share s′₆₇=g₇(6) 1416B and the set 1420B of other intermediate generation shares s′₁₇=g₇(1) . . . s′₅₇=g₇(5) 1422B to 1430B.

In any and all example implementations mentioned herein, it will be appreciated that the player devices of such sets of preceding generation player devices may not all be of the same generation. A set of preceding generation player devices can comprise multiple respective generations ranging from every player device being from a different generation to one or more player devices of the set being from different generations and one or more player devices of the set being from the same generation. Similarly, a set of intermediate generation player devices may not all be of the same generation. A set of intermediate generation player devices can comprise multiple respective generations ranging from every player device being from a different generation to one or more player devices of the set being from different generations and one or more player devices of the set being from the same generation. Also, a set of succeeding generation player devices may not all be of the same generation. A set of succeeding generation player devices can comprise multiple respective generations ranging from every player device being from a different generation to one or more player devices of the set being from different generations and one or more player devices of the set being from the same generation.

Having determined respective shares in a secret, any and all example implementations can make the secret available or facilitate recovering the secret by a threshold number of player devices with respective shares collaborating according to an associated threshold scheme.

Therefore, the ability to issue shares is extended using a protocol of multi-layered secret sharing, which comprises a protocol for distributing and recombining shares without compromising the security of the shared secret. This can be realised by decentralizing the frontloading approach in which players or player devices can generate the information required for frontloading without a central entity.

It will be appreciated that secret sharing can improve security and usability in various applications such as, for example, user authentication, in particular, multi-device based authentication (MDBA). Secret sharing is also relevant to threshold authorisation scenarios such as, for example, remote lock and wipe features in Data as a Service or other services such as web services.

The ability to issue new shares of a secret without relying on a central entity is useful in the MDBA setting and other settings of secret sharing. A new share can be issued or created if
a device is upgraded, lost, or damaged,
a share of the secret is lost or damaged; or
a user simply wants to add another device to their authentication system.

Meanwhile, for reasons of security and cost, a central entity is not always available to issue new shares. In some implementations of secret sharing, there is no central entity in the first place. Moreover, a centralised entity represents a risk that must be managed by the service provider. A solution that removes this risk is highly valuable.

Various properties are useful in a mechanism for issuing shares without a central entity. This includes low communication complexity, fewer requirements for the player devices to broadcast metadata, robustness against delays and revoked decisions, and flexibility in the choice of thresholds. Other properties include the option of decentralised setup and few restrictions on the player devices who can participate in issuing shares.

It will be appreciated that the above example implementations defines various threshold scheme having respective thresholds such as, for example, thresholds t, t′, t*, t″, t″″, or any other threshold. The various thresholds can have respective values. The respective threshold values can be different values, or one or more subsets of the threshold values can have the same threshold value.

The example implementations described above make reference to recovering the secret once a share or a threshold set of shares in the secret have been determined. However, example implementations are not limited to such an arrangement. Example implementations can be realised in which the shares are used for some other purpose like enabling other cryptographic operations such as, for example, at least one or more of signing, encrypting, or decrypting. Example implementations can realise those operations without ever reconstructing the key in any place.

Implementations can be realised in accordance with the following example implementations or clauses:

Example implementation provide for accessing a new share by a new player, P7, the access being facilitated by an earlier new player, P6, and a subset of initial player devices [P1 . . . P5].

Clause 1: A computer implemented method for a succeeding generation player device [P7] accessing an unassigned share [f(7)] in a secret, SK, the method comprising:
receiving, from an intermediate generation player device [P6], an intermediate generation share [s′₆₇=g₇(6)] of a set of intermediate shares, the intermediate generation share [s′₆₇=g₇(6)] being arranged to facilitate access to the unassigned share [f(7)] and the intermediate generation share [s′₆₇=g₇(6)] having been derived by the intermediate generation player device [P6] from shares of shares provided by a set of preceding generation player devices [P1 . . . P5];
receiving, from a set of other intermediate generation player devices [P1 . . . P5], a set of other intermediate generation shares [s′₁₇=g₇(1) . . . s′₅₇=g₇(5)] of the set of intermediate shares, to facilitate access by the succeeding generation player device [P7] to the unassigned share [g₇(0)=s₇=ƒ(7)] in conjunction with the intermediate generation share [s′₆₇=g₇(6)]; and
accessing the unassigned share [g₇(0)=s₇=ƒ(7)] using the intermediate generation share [s′₆₇=g₇(6)] and the set of other intermediate generation shares [s′₁₇=g₇(1) . . . s′₅₇=g₇(5)].

Example implementations provide for at least one of issuing or facilitating access to an unassigned share to a new player, P7, including a previously added new player, P6, taking part in the assigning.

Clause 2: A computer implemented method for issuing an unassigned share [f(7)] in a secret, SK, to a player device [P7], the method comprising:
a set of preceding generation player devices [P1 . . . P5] providing to an intermediate generation player device [P6], shares of a set of further shares to allow the intermediate generation player device [P6] to calculate an intermediate generation share [s′₆₇=g₇(6)] of a set of intermediate shares from which a succeeding generation player device [P7], together with a set of other intermediate generation shares [s′17=g₇(1) . . . s′₅₇=g₇(5)] of the set of intermediate shares provided by respective other intermediate generation player devices [P1 . . . P5], can calculate the unassigned share [g₇(0)=s₇=ƒ(7)]; and
the intermediate generation player device [P6] and the respective set of other intermediate generation player devices providing the intermediate generation share and the set of the other intermediate generation shares [s′₁₇=g₇(1) . . . s′₅₇=g₇(5)] to the player device, P7.

Clause 3: The method of either of clauses 1 and 2, comprising at least one of generating the secret, SK, or pre-secret keys to form the secret, SK.

Clause 4: The method of clause 3, comprising generating a set of shares {si or f(i):1≤i≤u} in the secret; the set of shares in the secret comprising a set of assigned shares {s1=f(1) . . . sn=f(n)} associated with an initial set of (for example, preceding generation) player devices and a set of unassigned shares {sn+1=f(n+1) . . . su=f(u)} to be assigned to additional player devices including the intermediate generation player device and the succeeding generation player device.

Clause 5: The method of clause 4, wherein generating the set of shares in the secret comprises: generating ƒ(i) of a polynomial ƒ(x) where ƒ(i) is a share of the secret, SK, assigned to player device i where 1≤i≤u.

Clause 6: The method of clause 5, in which ƒ(x) is of the form ƒ(x)=Σᵢ₌₁^{t-1}αᵢxⁱ+SK, where αᵢ∈ [symbol] /m [symbol] are randomly chosen coefficients and t is the threshold required to use or recover SK.

Clause 7: The method of any of any preceding clause, comprising
generating the set of intermediate (for example, sub-shares) shares {sij:n+1≤j≤u} from the set of shares in the secret, SK; the set of intermediate shares allowing a new (for example, intermediate generation or succeeding generation) player device of the additional player devices to be assigned a respective unassigned share of the set of unassigned shares.

Clause 8: The method of clause 7, wherein generating the set of intermediate (sub-)shares from the set of shares in the secret, SK, comprises:
generating intermediate (sub-)shares, gⱼ(i)∈{gₙ₊₁(i) to gᵤ(i):n+1≤j≤u}, in the unassigned shares ƒ(n+1) to ƒ(u), of the secret, SK, where gⱼ(i) facilitates new player j in determining ƒ(j), and where u is the total number of shares of the secret, SK.

Clause 9: The method of clause 8, in which gⱼ(x) is of the form gⱼ(x)=Σᵢ₌₁^{t′-1}βᵢxⁱ+ƒ(j) where βᵢ∈ [symbol] /m [symbol] are randomly chosen coefficients and t′ is the threshold to assign unassigned share ƒ(j) to the new player device.

Clause 10: The method of any preceding clause, comprising
generating the set of further shares (for example, the further sub-shares) {sijk:n+1≤j≤u, n+1≤k≤u} in the set of intermediate shares (for example, sub-shares); the set of further shares in the intermediate shares allowing a further new player device of the additional player devices to be assigned a respective unassigned share of the set of unassigned shares.

Clause 11: The method of clause 10, in which generating the set of further shares comprises:
generating further shares, h_{k,j}(i)∈{h_{j+1,j}(i) to h_{u,j}(i)}, in the intermediate shares, gⱼ(i)∈{gₙ₊₁(i) to gᵤ(i):n+1≤j≤u}, where h_{j+1,j}(i) to h_{u,j}(i) further shares facilitate player j, where n+1≤j≤u, in determining respective intermediate (sub-)shares, gⱼ₊₁(i) to gᵤ(i).

Clause 12: The method of clause 11, in which h_{k,j}(x) is of the form h_{k,j}(x)=Σᵢ₌₁^{t*-1}γᵢxⁱ+gₖ(j) where γᵢ∈ [symbol] /m [symbol] are randomly chosen coefficients and t* is the threshold to assign the intermediate (sub-)share to the new player device.

Clause 13: A computer implemented method for issuing an unassigned share [ƒ(7)] in a secret, SK, to a player device [P7], the method comprising:
generating a secret, SK;
generating a set of shares {si:1≤i≤u} in the secret; the set of shares in the secret comprising a set of assigned shares {s1 . . . sn} associated with an initial set of (preceding generation) player devices and a set of unassigned shares {sn+1 . . . su} to be assigned to additional player devices including an intermediate generation player device and a succeeding generation player device;
generating a set of intermediate (sub-)shares {sij:n+1≤j≤u} from the set of shares in the secret, SK; the intermediate set of shares allowing a new (intermediate generation or succeeding generation) player device of the additional player devices to be assigned a respective unassigned share of the set of unassigned shares;
generating a set of further (sub-sub-)shares {sijk:n+1≤j≤u, n+1≤k≤u} in the set of intermediate (sub-shares); the set of further (sub-sub-share) shares in the intermediate shares allowing a further new player device of the additional player devices to be assigned a respective unassigned share of the set of unassigned shares;
a set of preceding generation player devices [P1 . . . P5] providing to an intermediate generation player device [P6], shares of the set of further shares to allow the intermediate generation player device [P6] to calculate an intermediate generation share [s′₆₇=g₇(6)] from which a succeeding generation player device [P7], together with a set of other intermediate generation shares [s′₁₇=g₇(1) . . . s′₅₇=g₇(5)], provided by respective other intermediate generation player devices [P1 . . . P5], can calculate the unassigned share [g₇(0)=s₇=ƒ(7)]; and the intermediate generation player device [P6] and the respective set of other intermediate generation player devices providing the intermediate generation share and the set of the intermediate generation shares [s′₁₇=g₇(1) . . . s′₅₇=g₇(5)] to the player device, P7.

Example implementations provide for accessing a new share by a new player, P7, the access being facilitated by an earlier new player, P6, and a subset of initial player devices [P1 . . . P5].

Clause 14: A computer implemented method for a succeeding generation player device [P7] accessing an unassigned share [f(7)] in a secret, SK, the method comprising:
receiving, from an intermediate generation player device [P6], an intermediate generation share [s′₆₇=g₇(6)] of a set of intermediate shares, the intermediate generation share [s′₆₇=g₇(6)] being arranged to facilitate access to the unassigned share [f(7)] and the intermediate generation share [s′67=g₇(6)] having been derived by the intermediate generation player device [P6] from shares of further (sub-sub)shares provided by a set of preceding generation player devices [P1 . . . P5];
receiving, from a set of other intermediate generation player devices [P1 . . . P5], a set of other intermediate generation shares [s′₁₇=g₇(1) . . . s′₅₇=g₇(5)] of the set of intermediate shares, to facilitate access by the succeeding generation player device [P7] to the unassigned share [g₇(0)=s₇=ƒ(7)] in conjunction with the intermediate generation share [s′₆₇=g₇(6)]; and
accessing the unassigned share [g₇(0)=s₇=ƒ(7)] using the intermediate generation share [s′₆₇=g₇(6)] and the set of other intermediate generation shares [s′₁₇=g₇(1) . . . s′₅₇=g₇=g₇(5)].

Example implementations provide for provisioning a new player P6 to assist in issuing an unassigned share to a further new player, P7.

Clause 15: A computer implemented method for provisioning an intermediate generation player device [P6] to assist in issuing an unassigned share [b(7)] to a player device [P7], the method comprising:
a set of preceding generation player devices [P1 . . . P5] providing to the intermediate generation player device [P6], shares of a set of further (sub-sub-)shares to allow the intermediate generation player device [P6] to calculate an intermediate generation share [s′₆₇=g₇(6)] of a set of intermediate shares from which a succeeding generation player device [P7], together with a set of other intermediate generation shares [s′₁₇=g₇(1) . . . s′₅₇=g₇(5)] of the set of intermediate shares provided by respective other intermediate generation player devices [P1 . . . P5], can calculate the unassigned share [g₇(0)=s₇=ƒ(7)];

Example implementations provide for provisioning the initial players P1 . . . 5, to provision a new player, P6, to issue an unassigned share to a further new player, P7.

Example implementations provide for global provisioning of all player devices in the system.

Clause 16: A method for provisioning preceding generation players [P1 . . . P5] for issuing an unassigned share [f(7)] to a succeeding generation player [P7], the method comprising:
generating shares of a set of further (sub-sub-)shares, by the preceding generation players [P1 . . . P5] or a dealer, to be provided to an intermediate generation player device [P6] to allow the intermediate generation player device [P6] to calculate an intermediate generation share [s′₆₇=g₇(6)] of a set of intermediate shares from which the succeeding generation player [P7], together with a set of other intermediate generation shares [s′₁₇=g₇(1) . . . s′₅₇=g₇(5)] of the set of intermediate shares provided by respective other intermediate generation player devices [P1 . . . P5], can calculate the unassigned share [g₇(0)=s₇=ƒ(7)].

Example implementations provide for provisioning an individual player device to provide access to a share to a new player, P7, including provisioning an earlier new player, P6.

Clause 17: A method for provisioning a preceding generation player [P1 . . . P5] for issuing an unassigned share [f(7)] to a succeeding generation player [P7], the method comprising: generating a share of a set of further (sub-sub)shares, by the preceding generation player [P1 . . . P5] or a dealer, to be provided to an intermediate generation player device [P6] to allow the intermediate generation player device [P6] to calculate an intermediate generation share [s′₆₇=g₇(6)] of a set of intermediate shares from which the succeeding generation player [P7], together with a set of one or more other intermediate generation shares [s′₁₇=g₇(1) . . . s′₅₇=g₇(5)] of the set of intermediate shares provided by respective one or more other intermediate generation player devices [P1 . . . P5], can calculate the unassigned share [g₇(0)=s₇=ƒ(7)].

Clause 18: A device for provisioning a preceding generation player device for issuing an unassigned share to a succeeding generation player device, the device comprising circuitry arranged to generate a share of a set of further sub-shares, by the preceding generation player, to be provided to an intermediate generation player device to allow the intermediate generation player device to calculate an intermediate generation share of a set of intermediate shares from which the succeeding generation player device, together with a set of one or more other intermediate generation shares of the set of intermediate shares provided by respective one or more other intermediate generation player devices, can calculate the unassigned share.

Clause 19: The device of clause 18 comprising a communication interface for outputting the share of the set of further sub-shares to the intermediate generation player device.

Clause 20: The device of clause 19 in which the communication interface is arranged to receive the share of the set of further sub-shares from another entity.

Clause 21: Machine readable storage storing instructions arranged, when processed by a processor, to implement a method of any preceding clause.

Clause 22: A system for processing shares in a secret; the system comprising circuitry arranged to implement a method of any of preceding clause.

Clause 23: A player device for processing shares in a secret, the player device comprising circuitry arranged to implement a method of any of preceding clause.

Example implementations can comprise data structures, messages or signals for realising share issue and provisioning. The player devices communicate between one another via the respective communication interfaces, which can output and receive messages, or signals, bearing information associated with the shares, sub-shares and further sub-shares, or any set or sets thereof.

Clause 24: A message comprising data associated with a share; the data having been derived data associated with shares in the share associated with respective earlier generation player devices; the data associated with the share facilitating access by a recipient player device to a share associated with or in a secret.

Clause 25: An electronic message or signal to be output to or to be received by a player device such as, for example, player device PD7 109P7; the message comprising data associated with a sub-share, for example sub-share (s′_{6,7}); the data having been derived from data associated with further sub-shares, for example, further sub-shares {s*_{3,6,7}, s*_{4,6,7}, s*_{5,6,7}}, in the sub-share (s′_{6,7}) associated with, or received from, a number of earlier generation messages transmitted by respective earlier generation player devices (for example, player devices P3, P4, P5); the data associated with the sub-share (s′_{6,7}) facilitating access by the player device PD7 109 to a share, for example, (s₇), associated with, or in, a secret.

Clause 26: An electronic message or signal comprising data associated with a sub-share; the data having been derived data associated with further sub-shares in the sub-share associated with respective earlier generation messages; the data associated with the sub-share facilitating access by a recipient player device to a share associated with, or in, a secret.

1. Machine-readable storage storing machine executable instructions arranged, when processed by a processor, for a succeeding generation player device accessing an unassigned share in a secret, SK, the instructions comprising instructions to:
receive, from an intermediate generation player device, an intermediate generation share of a set of intermediate shares, the intermediate generation share being arranged to facilitate access to the unassigned share and the intermediate generation share having been derived by the intermediate generation player device from shares of shares provided by a set of preceding generation player devices;
receive, from a set of other intermediate generation player devices, a set of other intermediate generation shares of the set of intermediate shares, to facilitate access by the succeeding generation player device to the unassigned share in conjunction with the intermediate generation share; and
access the unassigned share using the intermediate generation share and the set of other intermediate generation shares.

2. The machine-readable storage of claim 1 comprising instructions to at least one of generate the secret, SK, or pre-secret keys to form the secret, SK.

3. The machine-readable storage of claim 2 comprising instructions to generate a set of shares in the secret; the set of shares in the secret comprising a set of assigned shares associated with an initial set of player devices and a set of unassigned shares to be assigned to additional player devices including the intermediate generation player device and the succeeding generation player device.

4. The machine-readable storage of claim 3, wherein the instructions to generate the set of shares in the secret comprise instructions to generate ƒ(i) of a polynomial ƒ(x) where ƒ(i) is a share of the secret, SK, assigned to player device i where 1≤I≤u.

5. The machine-readable storage of claim 4, in which ƒ(x) is of the form ƒ(x)=Σᵢ₌₁^{t-1}αᵢxⁱ+SK, where αᵢ∈ [symbol] /m [symbol] are randomly chosen coefficients and t is the threshold required to use or recover SK.

6. The machine-readable storage of claim 1 comprising instructions to:
generate the set of intermediate shares from the set of shares in the secret, SK;
the set of intermediate shares allowing a new player device of the additional player devices to be assigned a respective unassigned share of the set of unassigned shares.

7. The machine-readable storage of claim 6, wherein the instructions to generate the set of intermediate shares from the set of shares in the secret, SK, comprise instructions to:
generate intermediate shares, gᵢ(i)∈{gₙ₊₁(i) to gᵤ(i): n+1≤j≤u}, in the unassigned shares ƒ(n+1) to ƒ(u), of the secret, SK, where gᵢ(i) facilitates new player j in determining ƒ(j), and where u is the total number of shares of the secret, SK.

8. The machine-readable storage of claim 7, in which gⱼ(x) is of the form gⱼ(x)=Σᵢ₌₁^{t′-1}βᵢxⁱ+ƒ(j) where βᵢ∈ [symbol] /m [symbol] are randomly chosen coefficients and t′ is the threshold to assign unassigned share ƒ(j) to the new player device.

9. The machine-readable storage of claim 1 comprising instructions to:
generate a set of further sub-shares in the intermediate shares of the set of intermediate shares; the set of further sub-shares in the intermediate shares allowing a further new player device of the additional player devices to be assigned a respective unassigned share of the set of unassigned shares.

10. The machine-readable storage of claim 9, in which the instructions to generate the set of further sub-shares comprise instructions to:
generate further sub-shares, h_{k,j}(i)∈{h_{j+1,j}(i) to h_{u,j}(i)}, in the intermediate shares, gᵢ(i)∈{gₙ₊₁(i) to gᵤ(i): n+1≤j≤u}, where h_{j+1,j}(i) to h_{u,j}(i) further sub-shares facilitate player j, where n+1≤j≤u, in determining respective intermediate shares, gⱼ₊₁(i) to gᵤ(i).

11. The machine-readable storage of claim 10, in which h_{k,j}(x) is of the form h_{k,j}(x)=Σᵢ₌₁^{t*-1}γᵢxⁱ+gₖ(j) where γᵢ∈ [symbol] /m [symbol] are randomly chosen coefficients and t* is the threshold to assign the intermediate share to the new player device.

12. A computer implemented method for a succeeding generation player device accessing an unassigned share in a secret, SK, the method comprising:
receiving, from an intermediate generation player device, an intermediate generation share of a set of intermediate shares, the intermediate generation share being arranged to facilitate access to the unassigned share and the intermediate generation share having been derived by the intermediate generation player device from shares of further shares provided by a set of preceding generation player devices;
receiving, from a set of other intermediate generation player devices, a set of other intermediate generation shares of the set of intermediate shares, to facilitate access by the succeeding generation player device to the unassigned share in conjunction with the intermediate generation share; and
accessing the unassigned share using the intermediate generation share and the set of other intermediate generation shares.

13. A device for provisioning a preceding generation player device for issuing an unassigned share to a succeeding generation player device, the device comprising circuitry arranged to generate a share of a set of further sub-shares, by the preceding generation player, to be provided to an intermediate generation player device to allow the intermediate generation player device to calculate an intermediate generation share of a set of intermediate shares from which the succeeding generation player device, together with a set of one or more other intermediate generation shares of the set of intermediate shares provided by respective one or more other intermediate generation player devices, can calculate the unassigned share.

14. The device of claim 13 comprising a communication interface for outputting the share of the set of further sub-shares to the intermediate generation player device.

15. The device of claim 14 in which the communication interface is arranged to receive the share of the set of further sub-shares from another entity.
